(19) United States
(12) Patent Application Publication
(10) Pub. No.: US 2018/0040060 A1
(43) Pub. Date: Feb. 8, 2018

(54) DESCENDING COUNTER VALUE MATCHING FOR DIVISIBLE GOODS

(71) Applicant: Microsoft Technology Licensing, LLC, Redmond, WA (US)

(72) Inventors: Robert Kleinberg, Ithaca, NY (US); Glen Weyl, New York, NY (US)

(21) Appl. No.: 15/228,527

(22) Filed: Aug. 4, 2016

(51) Int. Cl. G06Q 30/08; G06Q 20/38; G06Q 40/04

(52) U.S. Cl. CPC G06Q 30/08; G06Q 40/04; G06Q 20/3829; G06Q 2220/00

(57) ABSTRACT

A descending price auction associated with a number of substantially indistinguishable items may be implemented by one or more computing devices including a counter module configured to generate a series of decreasing counter values, and a matching module configured to match a bidder and a particular quantity of items at least partly in response to a bid received by the computing device. The matching module matches the bidder and the particular quantity of items based at least partly on a particular counter value active when the bidder and the particular quantity of items are matched. Additionally, the matching module removes the items from the auction based at least partly on the matching, and determines the number of items remaining in the auction.

### BACKGROUND

Auctions can be useful in pairing items with bidders willing to pay a market price for such items. For example, sellers may provide various items for auction, and bidders may enter one or more “bids” for each of the items. In some auctions, the sellers may also enter a “reserve price” associated with each item, and bids below the reserve price may not be accepted. Conventional auctions are typically organized such that all matches between bidders and items/sellers occur simultaneously, or occur such that relatively low-value matches are demanded prior to relatively high-value transactions (often called ascending price auctions). Such ascending price auctions are typically open to the public in order to attract a wide range of bidders. Other conventional allocation procedures, such as book building, are brokered by investment banks or other auctioneering entities that privately negotiate the sale of goods between a seller and one or more targeted bidders.

Although some investors may have the resources to discern an appropriate price for goods being offered in an open ascending price auction, such investors often have little incentive to participate in such auctions since any bid that such investors may enter will likely be followed by a higher bid from another bidder. As a result, any potential return for such investors may be lost. Additionally, while such investors may turn to private book building procedures to avoid the problem of being outbid in public ascending price auctions, the auctioneering entity brokering such book building procedures will typically charge a relatively high brokerage fee for facilitating the auction, thus making book building procedures a less than optimal alternative.

### SUMMARY

This disclosure describes systems and methods associated with auctions, such as descending price auctions, in which high-value purchases of substantially indistinguishable items occur prior to relatively low-value purchases of such items.

In an example auction scenario, a bid for a particular quantity of substantially indistinguishable items is received from a bidder participating in the auction. The bid may be received during the auction, and the auction may be governed by a counter or other like mechanism presenting a “counter value” (e.g., a monetary or non-monetary indication of value) that descends over time. At any given time during the auction, the counter value may represent the price at which a transaction can be made. In some examples, the substantially indistinguishable items available in the auction may include a quantity of shares in a company, a quantity of a certain commodity, a debt offering, or other such items, and a receiver providing the items for auction may also set a reserve price on a per item basis such that the items offered for auction may not be purchased once the counter value has decreased below the reserve price.

During such an auction scenario any bid entered by a bidder may be given a value equal to a particular counter value of the series of counter values that is active at the time the bid is received. For example, a bidder may wait until the counter value decreases to a per-item value that he or she is willing to pay for a particular quantity of the substantially indistinguishable items. When the counter value has decreased to a desirable value, the bidder may then enter a bid for the desired quantity of the items, and the bid will be given a per-item value equal to the counter value that is currently active. The bidder may then be matched with the particular quantity of the items at the current counter value, and the particular quantity of the substantially indistinguishable items may be removed from the auction. However, the bidder may remain an active participant in the auction until the counter value has decreased to a value less than or equal to the reserve price or until there are no more items remaining.

Such an example method may further include providing information to the respective computing devices of the bidders participating in the auction. For example, such information may be provided, via a communications network, using a dashboard and/or other such user interface that includes a variety of tools enabling the user to enter bids, specify a particular quantity of items that the bidder wishes to purchase, etc. Such dashboards may also indicate the current counter value, the number of items remaining in the auction, and a transaction history that is specific to the particular bidder. Such a transaction history may include, for example, a chart or other graphical illustration indicating the number of items already purchased by the particular bidder, the counter value(s) associated with such purchases, and one or more indicators identifying other purchases made by additional bidders participating in the current auction. In some examples, the transaction history and/or other parts of the dashboard may not identify the additional bidders with particularity.

As will be described in greater detail below, the example systems and techniques described herein reduce the number of user interactions needed to conduct an auction as compared to traditional public ascending price auctions. Additionally, the example systems and techniques described herein require reduced levels of computational complexity. Consequently, the systems and techniques of the present disclosure require less bandwidth and/or other network resources, as well as less memory, processor, and/or other computing device resources as compared to known network-based auctions. As a result, the embodiments described herein allow for improved network and computing device performance.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example centralized environment including an auction service usable to implement example auctions described herein.

FIG. 2 is a block diagram depicting an example auction service computing device usable to implement example auctions described in connection with the environment of FIG. 1.

FIG. 3 is a block diagram depicting an example user computing device usable to participate in example auctions described in connection with the environment of FIG. 1.

FIG. 4 is a block diagram depicting an example decentralized environment usable to implement example auctions described herein.

FIG. 5 is a block diagram depicting a further example user computing device usable to implement example auctions described in connection with the environment of FIG. 4.

FIG. 6A is a flow diagram that illustrates example methods associated with an example auction implemented in the environment illustrated in either FIG. 1 or FIG. 4.

FIG. 6B illustrates example user interfaces associated with the example auction described in connection with the flow diagram of FIG. 6A.

FIG. 6C illustrates additional example user interfaces associated with the example auction described in connection with the flow diagram of FIG. 6A.

FIG. 6D illustrates further example user interfaces associated with the example auction described in connection with the flow diagram of FIG. 6A.

FIG. 6E illustrates still further example user interfaces associated with the example auction described in connection with the flow diagram of FIG. 6A.

### DETAILED DESCRIPTION

### Overview

Examples described herein provide environments, systems, methods, and other techniques associated with descending price auctions for a plurality of substantially indistinguishable items. In the various auctions described herein, “bidders” may include individuals, companies, and/or other entities providing a bid associated with an item or items available in the auction. Such a “bid” may be, for example, an amount (e.g., a dollar amount or other currency amount) proposed by the bidder for matching the bidder and the item or items. As will be described below, in some examples, the items available in the auction may include commodities, shares of stock, debt offerings, probability stakes, or other substantially indistinguishable items (e.g., divisible goods). In such examples, a bid entered by a bidder may be an amount proposed by the bidder for matching the bidder with a particular quantity of the substantially indistinguishable items. Additionally, in the various auctions described herein, “receivers” may include individuals, companies, and/or other entities providing an item or items for auction. In some examples, a receiver providing an item or items for auction may provide a reserve price associated with the item or items. Such a “reserve price” may be, for example, a minimum amount (e.g., a dollar amount or other currency amount) that the receiver will accept for the item or items, and any bids below the reserve price may not be accepted during auctions of the present disclosure.

An “item” provided for an auction may include any tangible, digital, or other good or object, and/or any intangible good, service, or object that the receiver wishes to convey to a winning bidder via an auction. As noted above, in example auctions of the present disclosure, a receiver may provide a plurality of substantially identical and/or otherwise substantially indistinguishable items for the auction. Such substantially indistinguishable items may comprise any divisible goods or other items having substantially the same configuration, physical characteristics, qualities, and/or value (e.g., commodities, shares of stock, debt offerings, probability stakes, offices in an office space, raffle tickets, tokens, etc.).

The auctions described herein can take place in environments that include centralized systems in which a central server or other auction service computing device facilitates the auction between a number of bidders participating in the auction. Such auctions can also take place in environments that include decentralized systems in which respective computing devices of the plurality of bidders are configured to facilitate the auction without the use of a central computing device. The auctions described herein can be characterized as “one-sided auctions,” in which after a quantity or plurality of substantially indistinguishable items is provided for the auction by a receiver, the receiver remains substantially passive as the auction progresses. In any of the example auctions described herein, additional bidders and/or additional receivers may be prohibited from joining an auction once the auction has begun (e.g., once registration for the auction has closed, and/or once an initial counter value has been generated).

In any of the examples described herein, an auction may be governed by a series of counter values generated by one or more computing devices being used by the auction participants (e.g., bidders) and/or by one or more central auction service computing devices facilitating the auction. Such counter values may descend as the auction proceeds, and the counter values may be made available to all auction participants during the auction, such as by presenting the descending counter values via a computing device dashboard or other user interface. A bidder participating in such an auction may enter a bid for a particular quantity of the substantially indistinguishable items provided by a receiver participating in the auction, and the bidder may be matched with the particular quantity of substantially indistinguishable items based at least partly on the particular counter value that is active when the bid from the bidder is received. For example, the bidder may be matched with the particular quantity of substantially indistinguishable items at the particular counter value that was active when the bid was received. The bidder may then be responsible for providing payment for the particular quantity of items at a per-item price equal to the particular counter value. Once the bidder has been matched with the particular quantity of items, the particular quantity of items will be removed from the auction while the bidder may remain an active participant in the auction.

Additionally, the auction service computing device (in a centralized auction) or the respective computing devices of the bidders participating in the auction (in a decentralized auction) may calculate or otherwise determine a difference between the quantity of items originally provided by the receiver and the quantity of items matched to the bidder, and the difference may comprise the number of the substantially indistinguishable items remaining in the auction. As noted above, any of the techniques or methods described herein may also include providing information to the respective computing devices of the bidders participating in the auction, and such information may include the number of items remaining, as well as a currently active counter value corresponding to the remaining substantially indistinguishable items. The auction may proceed until there are no items remaining in the auction and/or until another stopping condition is reached. For example, one such alternative stopping condition may be that the counter value is less than or equal to a predetermined threshold value, such as zero or a reserve price set by the receiver.

In some of the example auctions described herein, a receiver may provide a plurality of substantially indistinguishable items for auction. At the beginning of an example one-sided auction, an initial counter value may be provided to all auction participants, and the initial counter value may begin to decrease. A bidder participating in such an auction may wait to enter a bid until the counter value reaches a value that he or she is willing to pay for a particular quantity of the substantially indistinguishable items available in the auction. When the counter value has decreased to such a value, the bidder may enter a bid for the particular quantity of items, and the bid will be given a per-item value equal to the counter value that is currently active. In such an example auction, the bidder may be instantly matched with the particular quantity of items at a per-item value equal to the counter value that is active at the time the bid is received. Since the receiver is only a passive participant in such a one-sided auction, the receiver may not tender a counter offer associated with the particular quantity of items.

Additionally, during any of the auctions described herein, the bidder may be provided with a dashboard, user interface, and/or other functionality via a computing device used by the bidder during the auction. For example, such dashboards may include one or more tools operable to enable the user to enter a bid for and/or otherwise purchase a particular quantity of the substantially indistinguishable items. Such tools may also enable the user to request and/or acquire additional information associated with the substantially indistinguishable items that may be useful to the bidder during the auction. In particular, systems of the present disclosure may enable the bidder to obtain such information prior to placing a bid. The dashboard may also provide information including the current counter value and the number of the substantially indistinguishable items remaining in the auction. Additionally, the dashboard may provide information including a transaction history indicating the bidder's previous activity in the auction. In some examples, the transaction history may indicate the particular quantity of items previously bid on and/or otherwise purchased by the bidder, the particular counter value at which the bidder was matched with the quantity of items, and an identifier that uniquely identifies the bidder. The transaction history may also indicate quantities of items previously purchased by other bidders in the auction, as well as the respective counter values at which the other bidders were matched with the respective quantities of items. In some examples, however, the identity of the other bidders participating in the auction may not be shared with the respective bidders. For example, while the transaction history of a first bidder may include an identifier that uniquely identifies the first bidder, the transaction history may omit identifiers that uniquely identify the other bidders participating in the auction with the first bidder.

Governing each of the example auctions described herein in accordance with a series of descending counter values results in relatively high-value bidding/purchases taking place before relatively low-value bidding/purchases. Accordingly, example auctions of the present disclosure may result in more economically efficient outcomes than conventional auctions.

Additionally, the example systems and techniques of the present disclosure reduce the number of user interactions needed to conduct the auction as compared to traditional public ascending price auctions. For example, traditional public ascending price auctions require each bidder to confirm, at each offered price (i.e., at each counter value), whether they are participating in the auction and to state a particular quantity of items he or she wants to purchase. The example systems and techniques of the present disclosure, on the other hand, only require bidders to place bids when the counter value drops to a level at which they want to bid on a quantity of the items. Since the example systems and techniques of the present disclosure only require individual bidders to provide an input, such as via a network, when the bidder wishes to place a bid, such systems and techniques reduce the overall amount of information transmitted via the network over the course of the auction relative to traditional public ascending price auctions. Consequently, the example systems and techniques of the present disclosure also reduce the bandwidth and/or other network resources being utilized, as well as the amount of memory, processor, and/or other computing device resources required for storing such information at the auction service computing device and/or at the computing device of each respective bidder.

Additionally, in order to facilitate the example auctions described herein, the example computing devices of the present disclosure need only generate and/or determine a current counter value, a current number of items remaining in the auction, and/or the time at which to decrement and/or otherwise decrease the counter value. Computing devices used to facilitate traditional public ascending price auctions, on the other hand, are required to generate and/or determine the above parameters as well as a number of additional parameters at each counter value, such as the number of shares demanded by each bidder. Thus, example auctions using the techniques described herein taking place in centralized or decentralized environments, may reduce the number and size of data transmissions and/or require reduced levels of computational complexity. Such reduced complexity levels can improve network and/or computing device performance in the various centralized environments described herein. Such reduced complexity levels can also improve network and/or computing device performance in decentralized environments, and may enable peer-to-peer applications operating on the respective computing devices of the individual bidders in such environments to reach mutual agreement in less time and utilizing reduced computing device resources.

Various environments, configurations of electronic devices, and methods operating and/or facilitating an auction are described further with reference to the figures. While many examples described herein relate to servers and other non-consumer electronic devices, other types of electronic devices can be used, e.g., as discussed with reference to the figures.

### Illustrative Environment

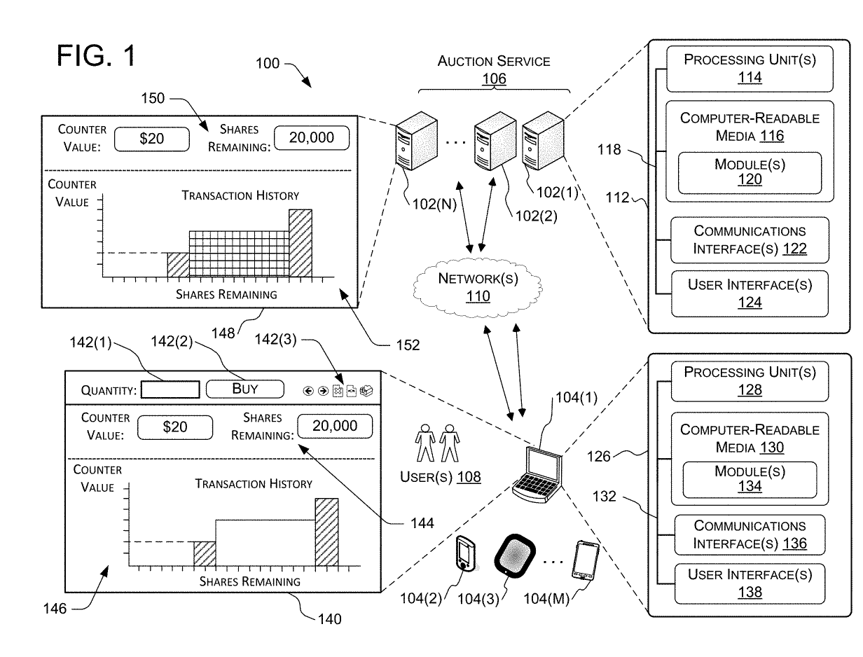

FIG. 1 shows an example environment 100 including an example system configured to operate an auction, and/or perform one or more of the methods described herein. In the illustrated example, one or more of the various devices and/or components of the environment 100 may comprise a system of the present disclosure, and such devices and/or components of the environment 100 may include computing device(s) 102(1)-102(N) (individually or collectively referred to herein with reference 102), where N is any integer greater than or equal to 1. The example environment 100 may also include computing devices 104(1)-104(M) (individually or collectively referred to herein with reference 104), where M is any integer greater than or equal to 1. Although illustrated as, e.g., desktop computers, laptop computers, tablet computers, cellular phones, personal digital assistants, and the like, the computing devices 102, 104 can include a diverse variety of device categories, classes, or types and are not limited to a particular type of device. In the illustrated example, computing devices 102 can be computing devices in an auction service 106. In some examples, the auction service 106 may comprise a cluster of computing devices and/or a cloud service. In the illustrated example, computing devices 104 can be clients of the auction service 106 and can submit bids, asks, modified bids, modified asks, information requests, messages, search queries, and/or other information to the auction service 106. Computing devices 104 can receive bids, asks, modified bids, modified asks, information requests, messages, search queries, and/or other information or content from the auction service 106. The computing devices 102 in auction service 106 can, e.g., share resources, balance load, increase performance, or provide fail-over support or redundancy.

In some examples, computing devices e.g., computing devices 102(1) and 102(2), can communicate with one another to participate in or carry out one or more of the operations described herein. For example, two or more of the computing devices 102 may cooperate to perform one or more steps or operations of an auction, such as a descending price auction, or other type of auction. Additionally, one or more of the computing devices 102, 104 may be operated by one or more respective users. For example, in an auction of the present disclosure, one or more of the computing devices 104 may be operated by user(s) 108. In such examples, one or more of the user(s) 108 may comprise a bidder participating in an auction via one or more network(s) 110 of the present disclosure. As noted above, one or more “bidders” of the present disclosure may include individuals, companies, and/or other entities providing a bid associated with an item or items available in the auction. Such a bid may be, for example, an amount (e.g., a dollar amount or other currency amount) proposed by the bidder for matching the bidder and a particular quantity of substantially indistinguishable items. Additionally, one or more of the user(s) 108 may comprise a receiver participating in an auction via one or more network(s) 110. One or more “receivers” of the present disclosure may include individuals, companies, and/or other entities providing an item or items for auction. As noted above, in some examples a receiver may provide a reserve price associated with the item or items provided for the auction. Such a “reserve price” may be, for example, a minimum amount (e.g., a dollar amount or other currency amount) that the receiver will accept for the item or items, and any bids below the reserve price may not be accepted during auctions of the present disclosure.

The various computing devices 102, 104 can communicate with each other or with other computing devices via the network(s) 110. In some examples, computing devices 102, 104 can also communicate with external devices via network(s) 110. For example, network(s) 110 can include public networks such as the Internet, private networks such as an institutional or personal intranet, or combination(s) of private and public networks. Network(s) 110 can also include any type of wired or wireless network, including but not limited to local area networks (LANs), wide area networks (WANs), satellite networks, cable networks, Wi-Fi networks, WiMAX networks, mobile communications networks (e.g., 3G, 4G, and so forth) or any combination thereof. Network(s) 110 can utilize communications protocols, such as, for example, packet-based or datagram-based protocols such as Internet Protocol (IP), Transmission Control Protocol (TCP), User Datagram Protocol (UDP), other types of protocols, or combinations thereof. Moreover, network(s) 110 can also include a number of devices that facilitate network communications or form a hardware infrastructure for the networks, such as switches, routers, gateways, access points, firewalls, base stations, repeaters, backbone devices, and the like. The computing devices 104 can receive access to any of the bids, asks, information associated with a plurality of items provided for an auction, and/or any of the other information described herein via the auction service computing devices 102 and/or via the network 110.

Different networks have different characteristics, e.g., bandwidth, latency, accessibility (open, announced but secured, or not announced), or coverage area. The type of network 110 used for any given connection between, e.g., a computing device 104 and auction service 106 can be selected based on these characteristics and on the type of interaction. Additionally, as will be described below, various file creation, modification, compression, encryption, and/or other processes performed by components of the systems described herein may improve the functionality of such networks. In particular, such processes may generate one or more packets, signals, files, and/or other content, such as compressed content. Transferring or processing such content may require reduced memory, processor, and/or other system resources. As a result, such content may be transmitted via the network 110 at faster speeds, and using reduced bandwidth. Accordingly, the generation and/or use of such content may result in improved network performance.

Details of an example computing device 102(1) are illustrated at inset 112. The details of the example computing device 102(1) can be representative of others of computing devices 102. However, each of the computing devices 102 can include additional or alternative hardware and/or software components. Still referring to the example of FIG. 1, computing device 102(1) can include one or more processing unit(s) 114 operably connected to one or more computer-readable media 116, e.g., memories, such as via a bus 118, which in some instances can include one or more of a system bus, a data bus, an address bus, a Peripheral Component Interconnect (PCI) Express (PCIe) bus, a PCI bus, a Mini-PCI bus, and any variety of local, peripheral, or independent buses, or any combination thereof. In some examples, plural processing units 114 can exchange data through an internal interface bus (e.g., PCIe), rather than or in addition to network 110. While the processing units 114 are described as residing on the computing device 102(1), in this example, the processing units 114 can also reside on different computing devices 102, in some examples. In some examples, at least two of the processing units 114 can reside on different computing devices 102. In such examples, multiple processing units 114 on the same computing device 102 can use a bus 118 of the computing device 102 to exchange data, while processing units 114 on different computing devices 102 (e.g., computing devices 102(1) and 102(2)) can exchange data via network(s) 110.

Computer-readable media described herein, e.g., computer-readable media 116, include computer storage media and/or communication media. Computer storage media includes tangible storage units such as volatile memory, nonvolatile memory, and/or other persistent and/or auxiliary computer storage media, removable and non-removable computer storage media implemented in any method or technology for storage of information such as computer-readable instructions, data structures, program modules, or other data. Computer storage media includes tangible or physical forms of media included in a device or hardware component that is part of a device or external to a device, including but not limited to RAM, static RAM (SRAM), dynamic RAM (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or memories, storage, devices, and/or storage media that can be used to store and maintain information for access by a computing device 102, 104. In contrast to computer storage media, communication media embodies computer-readable instructions, data structures, program modules, or other data in a modulated data signal, such as a carrier wave, or other transmission mechanism. As defined herein, computer storage media does not include communication media. In some examples, computer-readable media 116 can store instructions executable by the processing unit(s) 114, and the processing units 114 can be internal or external (e.g., virtual processing unit) to the computing device 102.

Computer-readable media 116 can store, for example, computer-executable instructions, an operating system, and/or other computer program instructions. The computer-readable media 116 can also store one or more module(s) 120 associated with an auction of the present disclosure. Such modules 120 may include, for example, a communication module, an encryption module, a matching module, a payment module, a compression module, and/or any other modules, programs, or applications that are loadable and executable by processing unit(s) 114.

Processing unit(s) 114 can be or include one or more single-core processors, multi-core processors, CPUs, GPUs, GPGPUs, or hardware logic components configured, e.g., via specialized programming from modules or APIs, to perform functions described herein. For example, and without limitation, illustrative types of hardware logic components that can be used in or as processing units 114 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processors (DSPs), and other types of customizable processors. For example, a processing unit 114 can be a hybrid device, such as a device from ALTERA or XILINX that includes a CPU core embedded in an FPGA fabric. These or other hardware logic components can operate independently or, in some instances, can be driven by a CPU. In some examples, at least some of computing device(s) 102, 104 can include a plurality of processing units 114 of multiple types. For example, the processing units 114 in computing device 102(3) can be a combination of one or more GPGPUs and one or more FPGAs. Different processing units 114 can have different execution models, e.g., as is the case for graphics processing units (GPUs) and central processing unit (CPUs).

The communications interface(s) 122 may be connected via the bus 118 to processing units 114 to enable wired or wireless communications between computing device(s) 102 and other networked computing devices 102, 104 over network(s) 110. Such communications interface(s) 122 can include one or more transceiver devices, e.g., network interface controllers (NICs) such as Ethernet NICs or other types of transceiver devices, to send and receive communications over a network. The processing units 114 can exchange data through respective communications interface(s) 122. In some examples, the communications interface 122 can be a PCI Express (PCIe) transceiver, and the network 110 can be a PCIe bus. In some examples, the communications interface 122 can include, but is not limited to, a transceiver for cellular (3G, 4G, or other), WI-FI, Ultra-wideband (UWB), BLUETOOTH, or satellite transmissions. The communications interface 122 can include a wired I/O interface, such as an Ethernet interface, a serial interface, a Universal Serial Bus (USB) interface, an INFINIBAND interface, or other wired interfaces. For simplicity, these and other components are omitted from the illustrated computing device 102(1).

In some examples, computing device 102 can also include one or more user interface(s) 124 configured to permit a user, e.g., an auctioneer, a data analyst or neural-network administrator, to operate one or more of the modules 120 and/or other components of the computing device 102 before, during, and/or after, for example, an auction of the present disclosure. In an example embodiment, a user interface 124 can include one or more output devices configured for communication to a user or to another computing device 102, 104. Output devices can be integral or peripheral to a computing device 102, 104. Examples of output devices can include a display, a printer, audio speakers, beepers, or other audio output devices, a vibration motor, linear vibrator, or other haptic output device, and the like. For example, the user interface 124 can include a display, such as an organic light-emitting-diode (OLED) display, a liquid-crystal display (LCD), a cathode-ray tube (CRT), or another type of visual display. Such a display can be a component of a touchscreen, or can include a touchscreen. User interface 124 can also include one or more input devices, integral or peripheral to a computing device 102, 104. The input devices can be user-operable, or can be configured for input from other computing device 102, 104. Examples of input devices can include, e.g., a keyboard, keypad, a mouse, a trackball, a pen sensor or smart pen, a light pen or light gun, a game controller such as a joystick or game pad, a voice input device such as a microphone, voice-recognition device, or speech-recognition device, a touch input device such as a touchscreen, a gestural or motion input device such as a depth camera, a grip sensor, an accelerometer, another haptic input, a visual input device such as one or more cameras or image sensors, and the like.

Details of an example computing device 104(1) are illustrated at inset 126. The details of example computing device 104(1) can be representative of others of computing device(s) 104. However, each of the computing device(s) 104 can include additional or alternative hardware and/or software components. Computing device 104(1) can include one or more processing unit(s) 128 operably connected to one or more computer-readable media 130, e.g., via a bus 132. The processing unit(s) 128 can be the same as or similar to the example processing units 114 discussed above. Additionally, the computer-readable media 130 can be the same as or similar to the example computer-readable media 116 described above. For example, computer-readable media 130 can include one or more computer storage media. Further, the bus 132 can be the same as or similar to the example bus 118 described above.

Computer-readable media 130 can store, for example, computer-executable instructions, an operating system, and/or other computer program instructions. The computer-readable media 130 can also store one or more module(s) 134 programs, or applications that are loadable and executable by processing unit(s) 128. Some examples of modules 134 are discussed above with reference to modules 120. As will be described below, the modules 134 can include modules that are the same as modules 120 and/or that are different from the modules 120.

Computing device 104 can also include one or more communications interfaces 136 connected via the bus 132 to processing unit(s) 128 to enable wired or wireless communications between computing device(s) 104 and other networked computing devices 102 involved in one or more auctions or other computing functions over network(s) 110. The communications interfaces 136 may be the same as or similar to the communications interface(s) 122 described above.

In some examples, computing device 104 can include a user interface 138 connected via the bus 132 to processing unit(s) 128. For example, computing device 104(1) can include a user interface 138 configured to enable a user 108 of the computing device 104(1) to control or otherwise interact with the computing device 104(1). Additionally or alternatively, the user interface 138 may be configured to enable a user 108 of the computing device 104(1) to control or otherwise interact with one or more of the other computing devices 104(M) via the network(s) 110. For example, processing unit(s) 128 can receive inputs of user actions via user interface 138 and transmit corresponding data via communications interface(s) 136 to computing device(s) 102 or 104(M). The user interfaces 138 may be the same as or similar to the user interfaces 124 described above.

Additionally, any of the computing devices 102, 104 described herein may be configured to provide one or more dashboards 140 or other user interfaces such as, via a display or other user interface of the computing device. As illustrated with respect to the computing device 104(1) of FIG. 1, an example dashboard 140 may provide a variety of information and functionality to a user 108 including, among other things, one or more tools 142(1), 142(2), 142(3) (collectively, “tools 142”) enabling the user 108 to perform various operations before, during, and/or after an example auction. For example, the dashboard 140 may include a first tool 142(1) comprising a data entry field configured to receive an input from the user 108. Such a data entry field may be configured to receive an input indicating, for example, a particular quantity of items that the user 108 wishes to bid on and/or otherwise purchase during an auction. The dashboard 140 may also include a second tool 142(2) configured to receive another input from the user 108. In particular, once the user 108 has entered a desired quantity of items in the data entry field of the tool 142(1), the user may touch, click, and/or otherwise provide an input via the second tool 142(2) to enter a corresponding bid and/or purchase during the auction. Additionally, the dashboard 142 may include one or more additional tools providing additional functionality to the user 108. Such additional tools 142(3) may enable the user 108 to, for example, request access to additional information related to the item or items (e.g., mandatory public disclosure documents) available in the auction, contact an underwriter associated with the receiver providing the items available in the auction, request that the current counter value be held for a certain period of time, and/or perform any number of additional operations associated with the auction and/or the items available.

Such an example dashboard 140 may also provide information 144 to the user 108 of the computing device 104. For example, such information 144 may include, among other things, a real-time counter value corresponding to the auction, a time until the next decrease or decrement of the current counter value, the number of substantially indistinguishable items remaining in the auction, names or other information indicating one or more additional participants in the auction, the total number of substantially indistinguishable items already purchased by the particular user 108, and/or the total amount of money or other currency that the particular user 108 has already spent in the auction. The dashboard 140 may also provide additional information 146 associated with the auction, and such additional information 146 may include, for example, a chart or other visual representation of a transaction history specific to the particular user 108. As noted above, such a dashboard 140 may be provided to, and may be tailored to, a bidder and/or a receiver during an auction. Accordingly, in some examples, the transaction history provided by the dashboard 140 may indicate the particular quantity of items previously bid on and/or otherwise purchased by the user 108, the particular counter value at which the user 108 was matched with the quantity of items, and an identifier that uniquely identifies the user 108. The transaction history may also indicate quantities of items previously purchased by other bidders in the auction, as well as the respective counter values at which the other bidders were matched with the respective quantities of items. In some examples, however, the identity of the other bidders participating in the auction may not be shared with the respective bidders. For example, while the transaction history of a first user 108 provided by the dashboard 140 may include an identifier that uniquely identifies the first user 108, the transaction history provided by the dashboard 140 may omit identifiers that uniquely identify the other bidders participating in the auction.

As illustrated with respect to the example computing device 102(N) of FIG. 1, an example dashboard 148 provided to an auctioneer and/or other user of a computing device 102 of the auction service 106 may be substantially similar to the dashboards 140 described above. For example, such an example dashboard 148 may provide a variety of information 150 and/or functionality to a user including, among other things, a real-time counter value corresponding to the auction, the number of substantially indistinguishable items remaining in the auction, names or other information indicating one or more participants in the auction, and/or other such information. The dashboard 148 may also provide additional information 152 associated with the auction, and such additional information 152 may include, for example, a chart or other visual representation of a transaction history specific to the auction and representative of the activities of each bidder participating in the auction. In some examples, the transaction history provided by the dashboard 148 may indicate the particular quantity of items previously bid on and/or otherwise purchased by each bidder, the particular counter value at which each respective bidder was matched with a corresponding quantity of items, and an identifier that uniquely identifies each of the bidders. Further details regarding the example dashboards 140, 148 described above will be provided below.

### Illustrative Components

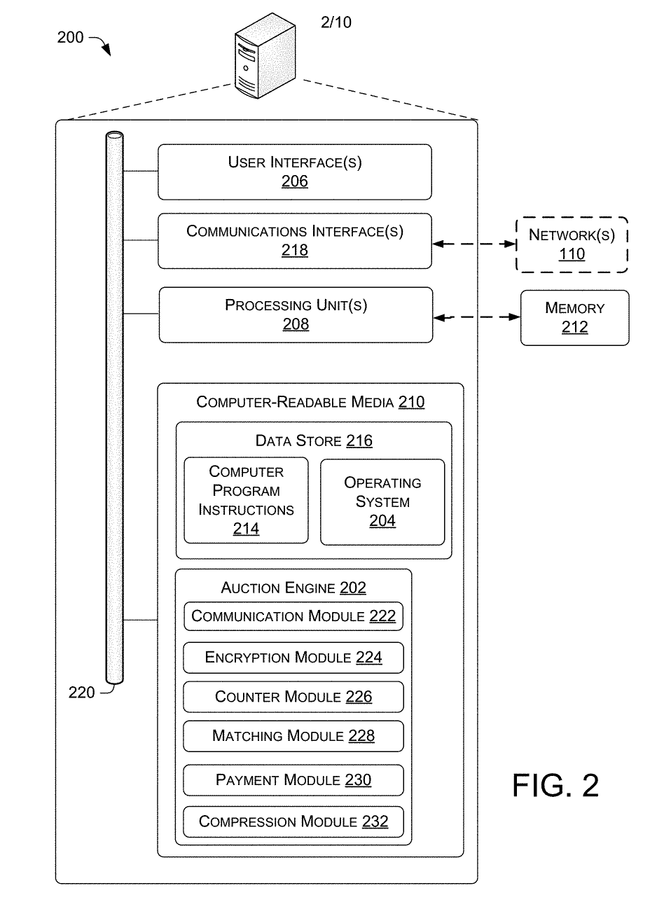

FIG. 2 is an illustrative diagram that shows example components of an auction service computing device 200, which can be similar to or the same as one or more of computing device(s) 104 and which can be a central server or other computing device configured to operate and/or otherwise facilitate an auction between two or more entities according to various examples described herein. Auction service computing device 200 can implement an auction engine 202, an operating system 204, and/or any other software or hardware component configured to operate such an auction.

Auction service computing device 200 can include or be connected to a user interface 206, which can be similar to or the same as the user interface 124 described above with respect to FIG. 1. The user interface 206 can include various types of output devices and/or input devices described above with reference to user interface 124. The user interface 206 can also include one or more input/output (I/O) interfaces to allow auction service computing device 200 to communicate with input, output, or I/O devices. Examples of such devices can include components of user interface 206 such as user-operable input devices and output devices described above with reference to user interface 124.

The auction service computing device 200 can include one or more processing unit(s) 208, which can be similar to or the same as processing unit(s) 114 described above with respect to FIG. 1. Processing units 208 can be operably coupled to the I/O interface and/or other user interface(s) 206, as well as to at least one computer-readable media 210, discussed below. Processing unit(s) 208 can include, e.g., processing unit types described above such as CPU- or GPGPU-type processing unit(s). In some examples, processing unit(s) 208 can include or be connected to a memory 212, e.g., a RAM or cache.

In some examples, computer-readable media 210 of the auction service computing device 200 can be similar to or the same as computer-readable media 116 described above with respect to FIG. 1, and can store a plurality of modules of the auction engine 202. The computer-readable media 210 can also store the operating system 204, as well as other items that will be described below. Processing unit(s) 208 can be configured to execute modules of the plurality of modules of the auction engine 202. For example, computer-executable instructions and/or other computer program instructions 214 stored within a data store 216 of the computer-readable media 210 can, upon execution, configure a computer such as an auction service computing device 200 to perform operations described herein with reference to the modules of the plurality of modules. The modules stored in the computer-readable media 210 can include instructions that, when executed by the one or more processing units 208, cause the one or more processing units 208 to perform operations described below.

In some examples, data store 216 can include data storage, structured or unstructured, such as a database (e.g., a Structured Query Language, SQL, or NoSQL database) or data warehouse. In some examples, data store 216 can include a corpus or a relational database with one or more tables, arrays, indices, stored procedures, and so forth to enable data access. Data store 216 can store data for the operations of processes, applications, components, or modules stored in computer-readable media 210 or computer instructions in those modules executed by processing unit(s) 208. In some examples, the computer program instructions 214 stored in the data store 216 may comprise instructions corresponding to processes described herein or to other software executable by processing unit(s) 208.

In some examples, the operating system 204 can include components that enable or direct the auction service computing device 200 to receive data via various inputs (e.g., user controls, network or communications interfaces, memory devices, or sensors), and process the data using the processing unit(s) 208 to generate output. The operating system 204 can further include one or more components that present the output (e.g., display an image on an electronic display, store data in memory, and/or transmit data to another computing device).

The auction service computing device 200 can also include a communications interface 218, which can be similar to or the same as communications interface 122 described above with respect to FIG. 1. For example, communications interface 218 can include a transceiver device such as a network interface controller (NIC) to send and receive communications over a network 110 (shown in phantom), e.g., as discussed above. As such, the auction service computing device 200 can have network capabilities. For example, the auction service computing device 200 can exchange data with computing devices 104 and/or other computing devices 104 (e.g., laptops, computers, and/or servers) via one or more network(s) 110, such as the Internet.

In some examples, the processing unit(s) 208 can access the module(s) on the computer-readable media 210 via a bus 220, which can be similar to or the same as bus 118 described above with respect to FIG. 1. User interface 206 and communications interface 218 can also communicate with processing unit(s) 208 via bus 220. The modules of the auction engine 202 stored on computer-readable media 210 can include one or more modules (e.g., shell modules, or API modules) which are illustrated as a communication module 222, an encryption module 224, a counter module 226, a matching module 228, a payment module 230, and a compression module 232. In the auction engine 202, the number of modules can vary higher or lower, and modules of various types can be used in various combinations. For example, functionality described associated with the illustrated modules can be combined to be performed by a smaller number of modules or APIs or can be split and performed by a larger number of modules or APIs. For example, the communication module 222 and the encryption module 224 can be combined in a single module that performs at least some of the example functions described below of those modules. Additionally or alternatively, the matching module 228 and the payment module 230 can be combined in a single module that performs at least some of the example functions described below of those modules. Further, the compression module 232 and the encryption module 224 can be combined in a single module that performs at least some of the example functions described below of those modules. In some examples, computer-readable media 210 may have thereon computer-executable instructions, the computer-executable instructions, upon execution, configuring a computer to perform operations described herein.

Example functionality associated with the modules 222, 224, 226, 228, and 230 of the auction engine 202 will be described in greater detail below with respect to example auctions. However, in some example systems of the present disclosure, the communication module 222 may be configured to receive information from a bidder of a plurality of bidders, and to receive information from a receiver of a plurality of receivers. Such information may be received, for example, using the communications interface 218 and via the network 110. In such examples, the information received from a bidder may include a name, address, Social Security Number, Employer Identification Number, bank account number, telephone number, email address, and/or other information identifying and/or otherwise describing the bidder. Such information may be provided by the bidder in order to, for example, register for an auction. Further, the information received from a receiver may include information describing an item or items provided for auction by the receiver. Such items may include any tangible, digital, or other good or object, and/or any intangible good, service, or object that the receiver wishes to convey to a winning bidder via an auction. As noted above, in some example auctions the receiver may provide a plurality of substantially indistinguishable items for an auction. Such, substantially indistinguishable items may comprise any divisible goods or other items having substantially the same configuration, physical characteristics, and/or value (e.g., shares, commodities, offices in an office space, debt, raffle tickets, tokens, etc.). Accordingly, in examples in which the plurality of substantially indistinguishable items comprises a block of stock shares, such information may include the company or other entity to which the shares correspond, the number of shares being offered in the auction, the class of shares (e.g., voting, non-voting, etc.), the current stock price as listed on a public market exchange (e.g., the New York Stock Exchange), a per-share reserve price associated with the block of shares, etc. Alternatively, in another example in which the plurality of substantially indistinguishable items comprises a commodity such as wheat, sugar, coffee, cocoa, gold, or oil, such information may include the type of commodity (e.g., wheat, sugar, coffee, etc.), the amount of the commodity being offered in the auction, a reserve price per unit of the commodity, a country/state/region/farm/mine of origin, etc. Such information may also include any other information descriptive of the particular item or items provided for auction by the receiver.

For example, in some embodiments the communication module 222 may be configured to receive first information from a computing device 104 of the bidder via the network 110, and to receive second information from a computing device 104 of the receiver via the network 110. In such examples, communications module 222 may comprise a component of a central server or other central computing device 102 facilitating the auction. In other examples, the communications module 222 may be a component of an application of the computing device 104 of the bidder. In such examples, the auction may proceed without the use of a central server or other central computing device 102 facilitating the auction.

In some example auctions, the communication module 222 may be configured to receive, from the bidder and during the auction, an information request associated with the item or items provided by the receiver. In such examples, the communication module 222 may also be configured to provide information associated with the item or items to the computing device 104 of the bidder. Additionally or alternatively, the communication module 222 may be configured to provide the computing device 104 of the bidder with access to such information via the network. For example, in embodiments in which the receiver provides public disclosure documents associated with shares of stock or other divisible items offered during the auction, such information may be stored in the computer-readable media 210. In such examples, the communication module 222 may provide the computing device 104 of the bidder with access to such information via the network 110 instead of or in addition to providing such information directly to the computing device 104 of the bidder. In some examples, the communication module 222 may provide such information to the computing device 104 of the bidder prior to receiving a bid on the item from the bidder, or from one or more additional bidders participating in the auction. Additionally, the communication module 222 may provide such information to the computing device 104 of the bidder at least partly in response to receiving the information request.

The communication module 222 may also be configured to receive a bid from the computing device 104 of at least one bidder of a plurality of bidders participating in the auction. Such a bid may comprise, for example, a quantity of the substantially indistinguishable items that the bidder wishes to procure from the receiver, at a price per unit equal to the counter value that is active when the bid is received by the communication module 222. Additionally, in some auctions, the communication module 222 may be configured to receive multiple bids from the computing devices 104 of multiple respective bidders. In such examples, each bid may comprise a quantity of the substantially indistinguishable items that the respective bidder proposes to procure from the receiver, and such amounts may be procured at a price per unit equal to the counter value that is active when the respective bids are received by the communication module 222.

The encryption module 224 may be configured to perform a variety of encryption, decryption, file conversion, file modification, and/or other functions associated with one or more example auctions of the present disclosure. For example, the encryption module 224 may be configured to encrypt the various information, messages, requests, bids, asks, and/or other electronic content (collectively referred to herein as “auction content”) received by the communication module 222 before, during, and/or after an auction. For example, such auction content may be received by the communication interface 218 and/or the communication module 222 in the form of signals, files, and/or packets, and such auction content may include an encryption key or other encoded information identifying, for example, the sender of the auction content. The encryption module 224 may receive such auction content as inputs, and may decrypt the auction content in order to authenticate the encryption key. The encryption module 224 may also authenticate the encryption key using one or more accepted receiver lists or other like information stored within the computer-readable media 210. The encryption module 224 may also verify the identity of the sender and/or the intended recipient of such auction content based at least partly on matching and/or otherwise authenticating the encryption key using the information stored within the computer readable media 210. In any of the example embodiments described herein, the encryption module 224 may perform any digital signature scheme or other cryptographic authentication scheme.

In still further examples, the encryption module 224 may be configured to encrypt such auction content prior to transmitting such content using the communication interface 218 and via the network 110. For example, the encryption module 224 may be configured to generate one or more encryption keys, and to embed and/or otherwise incorporate such encryption keys within the auction content prior to transmitting such auction content to a computing device 104 of a bidder, a receiver, and/or other intended recipient. Accordingly, the various information, messages, requests, bids, asks, and/or other auction content may be augmented, and/or otherwise altered by the encryption module 224 prior to being transmitted. As part of such an encryption process, and/or as a separate process associated with one or more of the example auctions described herein, encryption module 224 and/or the compression module 232 may modify the various information, messages, requests, bids, asks, and/or other auction content prior to transmitting such content using the communication interface, 218 and via the network 110. For example, the compression module 232 may compress, zip, and/or otherwise modify auction content, generated at least in part by the encryption module 224, thereby generating modified auction content prior to transmission. Relative to the original auction content, such modified auction content may have a reduced size, reduced bandwidth requirements, reduced memory requirement, and/or other such reduced characteristic. As a result, such modified auction content may be transmitted via the network 110 more quickly, may reduce the bandwidth and/or other system resources required for transmission, and/or may reduce the memory requirements of one or more of the computing devices 200, 102, 104 associated with storing such content. As a result, generation and utilization of such modified auction content by the encryption module 224 and/or by the compression module 232 may improve the efficiency of the system, components thereof, the network 110, and/or of the auction facilitated by the system.

The counter module 226 may be configured to generate a series of decreasing counter values during an auction of an item. For example, in auctions such as descending price auctions for a plurality of substantially indistinguishable items, the counter module 226 may generate an initial counter value that is greater than an expected or actual bid proposed by at least one bidder of a plurality of bidders. The counter module 226 may, during the course of the auction, generate a series of additional counter values, and the values included in the series of counter values may decrease over time from the initial counter value.

In general, a bidder and an item or items provided for auction by a receiver may be matched based at least partly on a particular counter value of the series of counter values that is currently active in real time. In some example auctions, the particular counter value may be active when a bid is received from the bidder for a particular quantity of substantially indistinguishable items, and “matching” the bidder with the particular quantity of items may comprise enabling the bidder to purchase the items. For example, in a one-sided descending price auction for a plurality of substantially indistinguishable items, a bidder may submit a bid for a particular quantity of the items at any time, and the system (e.g., the counter module 226 or the matching module 228) may automatically set the amount of the bid received from the bidder equal to the particular counter value that is active at the time the bid is received. In such an auction, the receiver may be a passive participant in the auction. For example, the receiver may set a reserve price, on a per-item basis, before the auction begins, and may not be permitted to affect the price of the plurality of substantially indistinguishable items during the auction. Accordingly, in such auctions the bid received from the bidder may comprise the particular quantity of the substantially indistinguishable items that the bidder wishes to purchase, and the per-item value of the bid may be set equal to the particular counter value that is active when the bid is received.

Due to the descending counter values described above, matches and/or other sales of items in which the willingness of the bidder to pay relatively high prices for particular quantities of substantially indistinguishable items are made earliest in the auction. Conversely, matches and/or other sales of items in which the willingness of the bidder to pay relatively low prices for particular quantities of substantially indistinguishable items are made later in the auction. In some examples, the communication module 222 may be configured to provide each value of the plurality of counter values generated by the counter module 226 to the respective computing devices 104 of each bidder of the plurality of bidders. Additionally, the communication module 222 may be configured to provide information associated with any of the dashboards described herein, such as the dashboards 140, to the respective computing devices 104 of the bidders. Such information may be provided, for example, electronically using the communication interface, 218 and via the network 110.

The matching module 228 may be configured to match the bidder and the particular quantity of the substantially indistinguishable items bid on by the respective bidder at least partly in response to a bid received by the communication module 222 from the bidder during the auction. For example, the matching module 228 may facilitate pairing the bidder with the particular receiver that provided the particular quantity of the substantially indistinguishable items for auction once the communication module 222 receives the bid from the bidder and/or once any other conditions or rules of the auction have been satisfied. In any of the auctions described herein, the matching module 228 may match the bidder and the particular quantity of the substantially indistinguishable items based at least partly on and/or in accordance with a particular counter value of the series of counter values active when the bid is received. The matching module 228 may also remove the particular quantity of the substantially indistinguishable items from the auction based at least partly on the matching. In example embodiments, however, the particular bidder may remain an active participant in the auction after the particular quantity of the substantially indistinguishable items has been removed. For example, the bidder may be maintained as an active participant in the auction until no further substantially indistinguishable items remain in the auction or until the counter value has decreased to a value less than or equal to a reserve price set by the receiver.

The payment module 230 may be configured to determine an amount that the bidder is responsible to provide to the receiver for the particular quantity of the substantially indistinguishable items as a condition of the bidder being matched with and/or otherwise purchasing the particular quantity of the substantially indistinguishable items in the auction. For example, at least partly in response to the matching module 228 matching a bidder with the particular quantity of the substantially indistinguishable items, the payment module 230 may be configured to determine an amount owed to the receiver by the bidder. In some examples, the payment module 230 may determine such an amount by multiplying the particular quantity bid on by the bidder by the per-unit counter value that was active when the bid was received from the bidder. For example, in an auction in which the bidder enters a bid for a quantity of 5,000 shares at a counter value of $60, the payment module may determine that an amount of $300,000 (i.e., 5,000×$60) is owed to the receiver by the bidder.

In some examples, the communication module 222 may be configured to provide a payment request to the bidder in order to facilitate payment from the bidder. In example auctions, the bidder may be responsible for paying the owed amount to the auction service 106 or other entity facilitating the auction. In yet another example, the bidder may be responsible for paying the amount owed directly to the receiver. In example embodiments of the present disclosure, the payment module 230 may comprise any application, component, system, or component within a system, configured to facilitate payments between bidders and receivers participating in an auction. For example, the payment module 230 may be operable to outsource payment interactions between bidders and receivers. In such examples, the payment module 230 may connect, for example, a bank account of a bidder with a bank account of a receiver in order to facilitate the transfer of funds between the bank accounts. In other examples, the payment module 230 may connect the computing device 200 to an external payment service or other payment platform used by auction participants to facilitate payments.

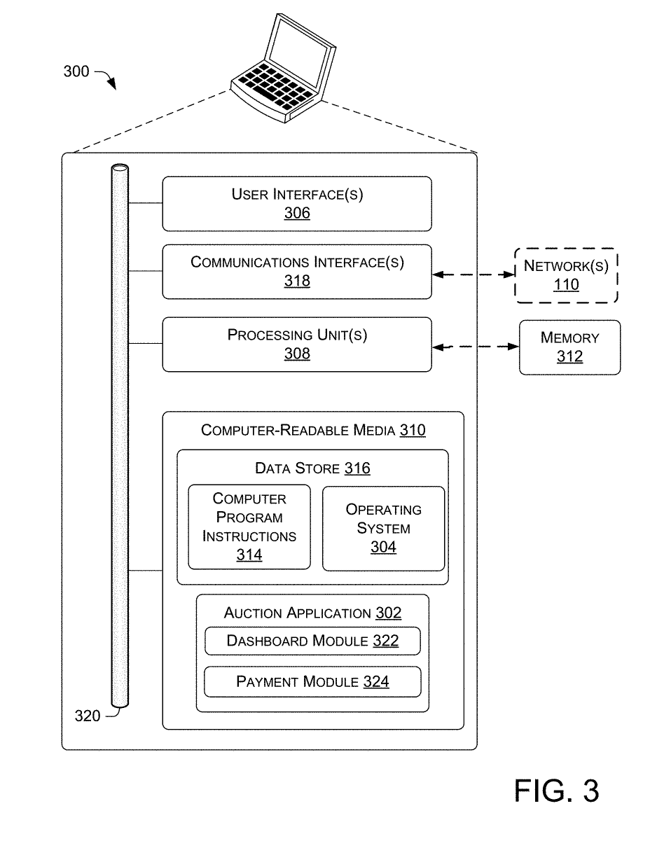

FIG. 3 is an illustrative diagram that shows example components of a user computing device 300, which can be similar to or the same as one or more of computing device(s) 102, 104, and which can be a computing device of a user 108. In particular, the user computing device 300 of FIG. 3 may comprise a computing device 104 of a bidder and/or a computing device of a receiver used during an example auction of the present disclosure. In such examples, the user computing device 300 may be used by either a bidder or a receiver in a centralized auction in which one or more additional computing devices 200 (FIG. 2) operates and/or otherwise facilitates the auction. In particular, the system 100 of FIG. 1 may be configured to facilitate such a centralized auction and, as noted above with respect to FIG. 2, an auction service computing device 200 may implement an auction engine 202, an operating system 204, and/or any other software or hardware component configured to operate and/or otherwise facilitate such an auction. In some examples, the user computing device 300 of FIG. 3 may access a website or other interface of the auction via a browser. In other examples, the user computing device 300 may include an auction application 302 usable to interact with the auction engine 202 of the auction service computing device 200, an operating system 304, and/or any other software or hardware component configured to enable a bidder and/or a receiver to participate in such an auction.

User computing device 300 can include or be connected to a user interface 306, which can be similar to or the same as user interface 138. The user interface 306 can include various types of output devices and/or input devices described above with reference to user interface 138. The user interface 306 can also include one or more input/output (I/O) interfaces to allow user computing device 300 to communicate with input, output, or I/O devices. Examples of such devices can include components of user interface 306 such as user-operable input devices and output devices described above with reference to user interface 138.

The user computing device 300 can include one or more processing unit(s) 308, which can be similar to or the same as processing unit(s) 128. Processing units 308 can be operably coupled to the I/O interface and/or other user interface(s) 306, as well as to at least one computer-readable media 310, discussed below. Processing unit(s) 308 can include, e.g., processing unit types described above such as CPU- or GPGPU-type processing unit(s). In some examples, processing unit(s) 308 can include or be connected to a memory 312, e.g., a RAM or cache.

In some examples, computer-readable media 310 of the user computing device 300 can be similar to or the same as computer-readable media 130, and can store a plurality of modules of the auction application 302. The computer-readable media 310 can also store the operating system 304, and the operating system 304 may be similar in function and operation to the operating system 204 described above with respect to auction service computing device 200. Processing unit(s) 308 can be configured to execute modules of the plurality of modules of the auction application 302. For example, computer-executable instructions and/or other computer program instructions 314 stored within a data store 316 of the computer-readable media 310 can upon execution configure a computer such as a user computing device 300 to perform operations described herein with reference to the modules of the plurality of modules. The modules stored in the computer-readable media 310 can include instructions that, when executed by the one or more processing units 308, cause the one or more processing units 308 to perform operations described below.

In some examples, data store 316 can include data storage, structured or unstructured, such as a database (e.g., a Structured Query Language, SQL, or NoSQL database) or data warehouse. In some examples, data store 316 can include a corpus or a relational database with one or more tables, arrays, indices, stored procedures, and so forth to enable data access. Data store 316 can store data for the operations of processes, applications, components, or modules stored in computer-readable media 310 or computer instructions in those modules executed by processing unit(s) 308. In some examples, the computer program instructions 314 stored in the data store 316 may comprise instructions corresponding to processes described herein or to other software executable by processing unit(s) 308.

The user computing device 300 can also include a communications interface 318, which can be similar to or the same as communications interface 136. For example, communications interface 318 can include a transceiver device such as a network interface controller (NIC) to send and receive communications over the network 110 (shown in phantom), e.g., as discussed above. As such, the user computing device 300 can have network capabilities. For example, the user computing device 300 can exchange data with the computing devices 102 and/or with one or more additional computing devices 104 via one or more network(s) 110, and in some examples, the user computing device 300 can receive data from one or more data source(s) (not shown) via one or more network(s) 110.

In some examples, the processing unit(s) 308 can access the module(s) on the computer-readable media 310 via a bus 320, which can be similar to or the same as bus 132. User interface 306 and communications interface 318 can also communicate with processing unit(s) 308 via bus 320. The modules of the auction application 302 stored on computer-readable media 310 can include one or more modules (e.g., shell modules, or API modules) which are illustrated as a dashboard module 322 and a payment module 324. In the auction application 302, the number of modules can vary higher or lower, and modules of various types can be used in various combinations. For example, functionality described associated with the illustrated modules can be combined to be performed by a fewer number of modules or APIs or can be split and performed by a larger number of modules or APIs.

Example functionality associated with the modules 322 and 324 of the auction application 302 will be described in greater detail below with respect to example auctions. However, in some example systems of the present disclosure, such as systems including a user computing device 300 configured for use in a centralized auction facilitated by one or more central servers or other central computing device(s) 102, the dashboard module 322 may be configured to receive a bid for a particular quantity of substantially indistinguishable items from a bidder of a plurality of bidders. For example, the dashboard module 322 may control a display or other user interface 306 of the computing device 300 to provide a dashboard, such as the dashboard 140 (FIG. 1) to a bidder during an auction. Such a dashboard may provide the bidder with information related to a plurality of substantially indistinguishable items available in an ongoing auction, and such information may include, for example, a current counter value and a number of items remaining and/or otherwise available in the auction. The bidder may enter, via a data entry field of the dashboard, a number indicating a particular quantity of substantially indistinguishable items that the user wishes to bid on and/or otherwise purchase during the auction. The bidder may also provide an input via a button, an additional data entry field, and/or other control of the dashboard, and such input may facilitate the submission of a bid for the particular quantity of substantially indistinguishable items at the currently active counter value. Although not described with respect to FIG. 2, it is understood that the computing device 200 may also include a similar dashboard module, and such a dashboard module may control a display or other user interface 206 of the computing device 200 to provide a dashboard, such as the dashboard 148 (FIG. 1) to an auctioneer or other user of the computing device 200 during an auction.

With continued reference to FIG. 3, the dashboard module 322 may also generate a dashboard providing information useful to the bidder in generating a bid for a particular quantity of substantially indistinguishable items. For example, as noted above, such a dashboard may include the counter value that is currently active, and the number of items remaining in the auction. Such a dashboard may also include various additional tools enabling the bidder to request information related to, for example, items available during the present auction, and/or any other information that may be useful to the bidder in placing a bid during the auction. Such a dashboard may further include information such as the transaction history described with respect to FIG. 1.

In some example systems of the present disclosure, such as systems including a user computing device 300 configured for use in a centralized auction facilitated by one or more central servers or other central computing device(s) 102, the payment module 324 may be configured to provide and/or facilitate providing electronic payment between the bidder and the receiver. In examples in which the user computing device 300 comprises a computing device of a bidder who must make a payment as a result of the outcome of the auction, the payment module 324 may be configured to enable the bidder to provide payment in the amount determined during the auction, and to route such payment to a bank account and/or other account of the party receiving such payment. As noted above with respect to FIG. 2, such amounts may be determined by the payment module 230 of the auction service computing device 200.

### Additional Illustrative Environment

As noted above, the example system 100 of FIG. 1 may comprise a system for use in a centralized auction. In such a centralized auction, one or more computing devices 102, 200 may operate and/or otherwise facilitate an auction for the purchase of a plurality of substantially indistinguishable (e.g., divisible) items according to various examples described herein. Additionally, one or more computing devices 104, 300 may implement an auction application 302, an operating system 304, and/or any other software or hardware component configured to enable a bidder and/or a receiver to participate in such a centralized auction.

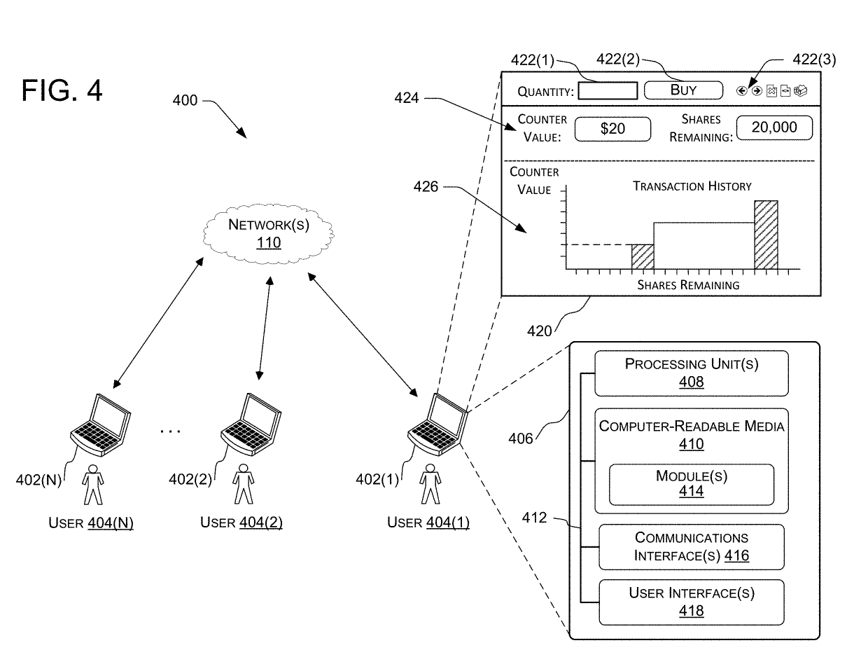

FIG. 4, on the other hand, illustrates an environment 400 comprising a system for use in a decentralized or “peer-to-peer” auction. In such a decentralized auction, the one or more computing devices 102, 200 described above with respect to FIGS. 1 and 2 may be omitted. Instead, one or more computing devices 402(1) . . . 402(N) (representing computing devices 104 and referred to singularly or collectively herein using reference 402) may operate and/or otherwise facilitate an auction for the purchase of a plurality of substantially indistinguishable (e.g., divisible) items according to various examples described herein. For example, users 404(1) . . . 404(N) (e.g., bidders) may utilize a respective one of the computing devices 402 to enter a bid and/or otherwise participate in a decentralized auction for the purchase of a plurality of substantially indistinguishable items provided by a receiver. In such examples, each of the computing devices 402 may implement an auction application, an operating system, and/or any other software or hardware component configured to enable a bidder and/or a receiver to participate in such a decentralized auction.

Details of an example computing device 402(1) are illustrated at inset 406. The details of example computing device 402(1) can be representative of others of computing device(s) 402. However, each of the computing device(s) 402 can include additional or alternative hardware and/or software components. Computing device 402(1) can include one or more processing unit(s) 408 operably connected to one or more computer-readable media 410, e.g., via a bus 412. Some examples of processing unit(s) 408 are discussed above with reference to processing unit(s) 114. Some examples of computer-readable media 410 are discussed above with reference to computer-readable media 116. For example, computer-readable media 410 can include one or more computer storage media. Some examples of bus 412 are discussed above with reference to bus 118.

Computer-readable media 410 can store, for example, computer-executable instructions, an operating system, and/or other computer program instructions. The computer-readable media 410 can also store one or more module(s) 414 associated with an auction of the present disclosure, and/or other modules, programs, or applications that are loadable and executable by processing unit(s) 418. Some examples of modules 414 are discussed above with reference to modules 120 and 134.

Computing device 402 can also include one or more communications interfaces 416 connected via the bus 412 to processing unit(s) 408 to enable wired or wireless communications between computing device(s) 402 and other networked computing devices 402 involved in one or more auctions or other computing functions over network(s) 110. Some examples of communications interfaces 416 are discussed above with reference to communications interface(s) 122.

In some examples, computing device 402 can include a user interface 418 connected via the bus 412 to processing unit(s) 408. For example, computing device 402(1) can include a user interface 418 configured to enable a user 404(1) of the computing device 402(1) to control or otherwise interact with one or more of the computing devices 402 via the network(s) 110. Some examples of user interfaces 418 are discussed above with reference to user interface 124.

Additionally, any of the computing devices 402 described herein may be configured to provide one or more dashboards 420 or other user interfaces, such as via a display or other user interface of the computing device. As illustrated with respect to the computing device 404(1) of FIG. 4, an example dashboard 420 may provide a variety of information and functionality to a user 404(1) including, among other things, one or more tools 422(1), 422(2), 422(3) (collectively, “tools 422”) enabling a user 404 to perform various operations before, during, and/or after an example auction. For example, the dashboard 420 may include a first tool 422(1) comprising a data entry field configured to receive an input from the user 404. Such a data entry field may be configured to receive an input indicating, for example, a particular quantity of items that the user 404 wishes to bid on and/or otherwise purchase during an auction. The dashboard 420 may also include a second tool 422(2) configured to receive another input from the user 404. In particular, once the user 404 has entered a desired quantity of items in the data entry field of the tool 422(1), the user may touch, click, and/or otherwise provide an input via the second tool 422(2) to enter a corresponding bid and/or purchase during the auction. Additionally, the dashboard 420 may include one or more additional tools providing additional functionality to the user 404. Such additional tools 422(3) may enable the user 404 to, for example, request access to additional information related to the item or items available in the auction, contact an underwriter associated with the receiver providing the items available in the auction, request that the current counter value be held for a certain period of time, and/or perform any number of additional operations associated with the auction and/or the items available.

Such an example dashboard 420 may also provide information 424 to the user 404 of the computing device 402. For example, such information 424 may include, among other things, a real-time counter value corresponding to the auction, the number of substantially indistinguishable items remaining in the auction, names or other information indicating one or more additional participants in the auction, the total number of substantially indistinguishable items already purchased by the particular user 404, and/or the total amount of money or other currency that the particular user 404 has already spent in the auction. The dashboard 420 may also provide additional information 426 associated with the auction, and such additional information 426 may include, for example, a chart or other visual representation of a transaction history specific to the particular user 404. The dashboard 420 may be similar to and/or the same as the dashboard 140 (FIG. 1) described above. Additionally, an example dashboard 420 may be provided to, and may be tailored to, a particular bidder and/or a particular receiver during an auction.

### Additional Illustrative Components

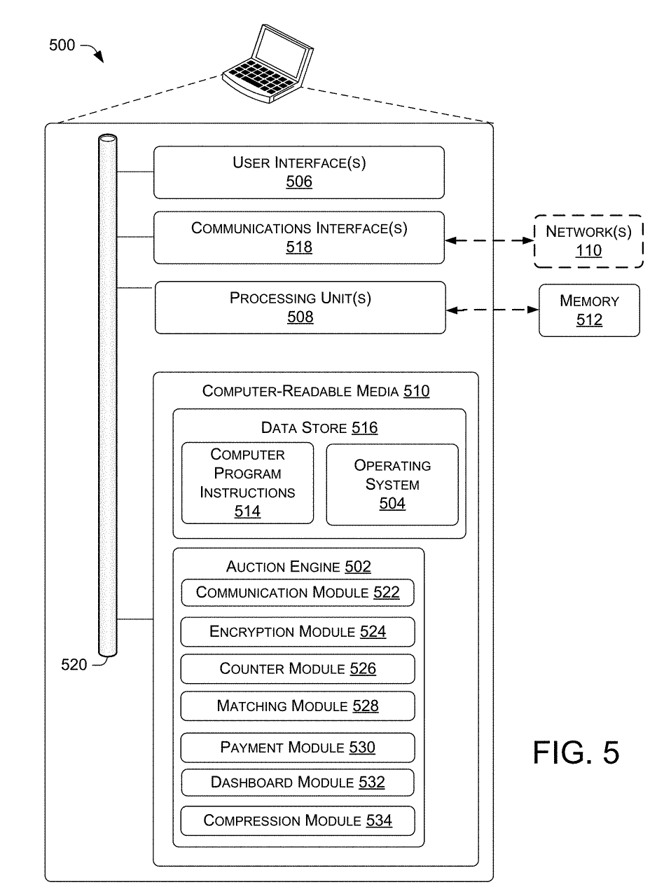

FIG. 5 is an illustrative diagram that shows example components of a computing device 500, which can be similar to or the same as one or more of computing device(s) 402, and which can be a computing device configured to operate and/or otherwise facilitate a decentralized auction for a plurality of substantially indistinguishable items according to various examples described herein. Computing device 500 can implement an auction engine 502, an operating system 504, and/or any other software or hardware component configured to operate such an auction.

Computing device 500 can include or be connected to a user interface 506, which can be similar to or the same as user interface 418. The user interface 506 can include various types of output devices and/or input devices described above with reference to user interface 418. The user interface 506 can also include one or more input/output (I/O) interfaces to allow computing device 500 to communicate with input, output, or I/O devices. Examples of such devices can include components of user interface 506 such as user-operable input devices and output devices described above with reference to user interface 418.

The computing device 500 can include one or more processing unit(s) 508, which can be similar to or the same as processing unit(s) 408. Processing units 508 can be operably coupled to the I/O interface and/or other user interface(s) 506, as well as to at least one computer-readable media 510, discussed below. Processing unit(s) 508 can include, e.g., processing unit types described above such as CPU- or GPGPU-type processing unit(s). In some examples, processing unit(s) 508 can include or be connected to a memory 512, e.g., a RAM or cache.

In some examples, computer-readable media 510 of the computing device 500 can be similar to or the same as computer-readable media 410, and can store a plurality of modules of the auction engine 502. The computer-readable media 510 can also store the operating system 504, and the operating system 504 may be similar in function and operation to the operating system 304 described above with respect to user computing device 300. Processing unit(s) 508 can be configured to execute modules of the plurality of modules of the auction engine 502. For example, computer-executable instructions and/or other computer program instructions 514 stored within a data store 516 of the computer-readable media 510 can upon execution configure a computer such as a computing device 500 to perform operations described herein with reference to the modules of the plurality of modules. The modules stored in the computer-readable media 510 can include instructions that, when executed by the one or more processing units 508, cause the one or more processing units 508 to perform operations described below.

The computing device 500 can also include a communications interface 518, which can be similar to or the same as communications interface 416. For example, communications interface 518 can include a transceiver device such as a network interface controller (NIC) to send and receive communications over the network 110 (shown in phantom), e.g., as discussed above. As such, the computing device 500 can have network capabilities. For example, the computing device 500 can exchange data with various other computing devices 402 via one or more network(s) 110, and in some examples, the computing device 500 can receive data from one or more data source(s) (not shown) via one or more network(s) 110.

In some examples, the processing unit(s) 508 can access the module(s) on the computer-readable media 510 via a bus 520, which can be similar to or the same as bus 412. User interface 506 and communications interface 518 can also communicate with processing unit(s) 508 via bus 520. The modules of the auction engine 502 stored on computer-readable media 510 can include one or more modules (e.g., shell modules, or API modules) which are illustrated as a communication module 522, an encryption module 524, a counter module 526, a matching module 528, a payment module 530, a dashboard module 532, and a compression module 534. In the auction engine 502, the number of modules can vary higher or lower, and modules of various types can be used in various combinations. For example, functionality associated with the illustrated modules can be combined to be performed by a fewer number of modules or APIs or can be split and performed by a larger number of modules or APIs.

Example functionality associated with the modules 522, 524, 526, 528, 530, and 534 of the auction engine 502 will be described in greater detail below with respect to example auctions. Such functionality may be substantially similar to and/or the same as the functionality described above with the communication module 222, encryption module 224, counter module 226, matching module 228, payment module 230, and the compression module 232 of the auction service computing device 200 shown in FIG. 2. Additionally, the functionality of the dashboard module 532 may be substantially similar to and/or the same as the functionality described above with respect to the dashboard module 322 of the user computing device 300 shown in FIG. 3.

### Illustrative Processes

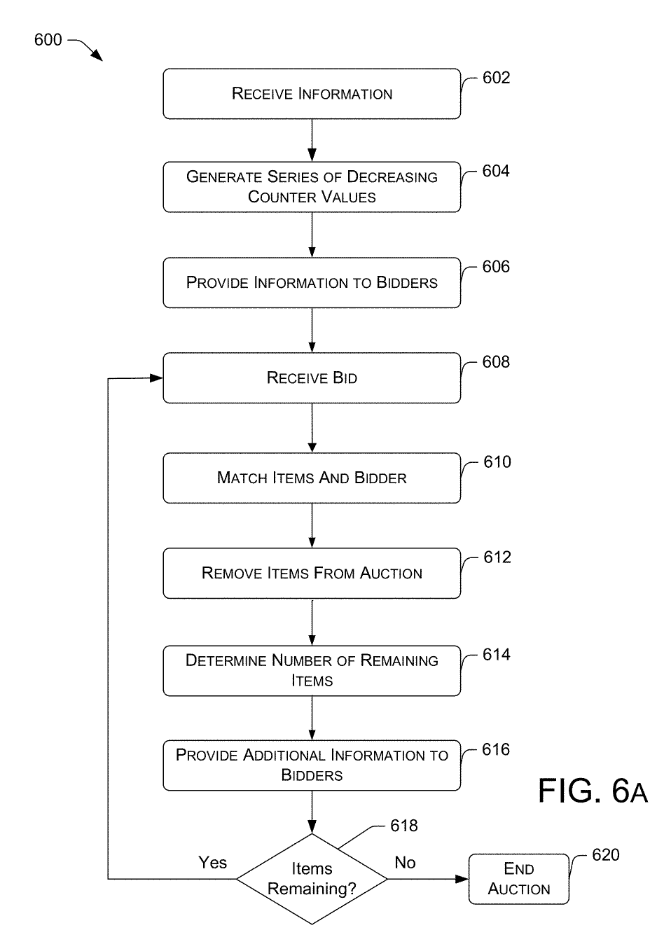

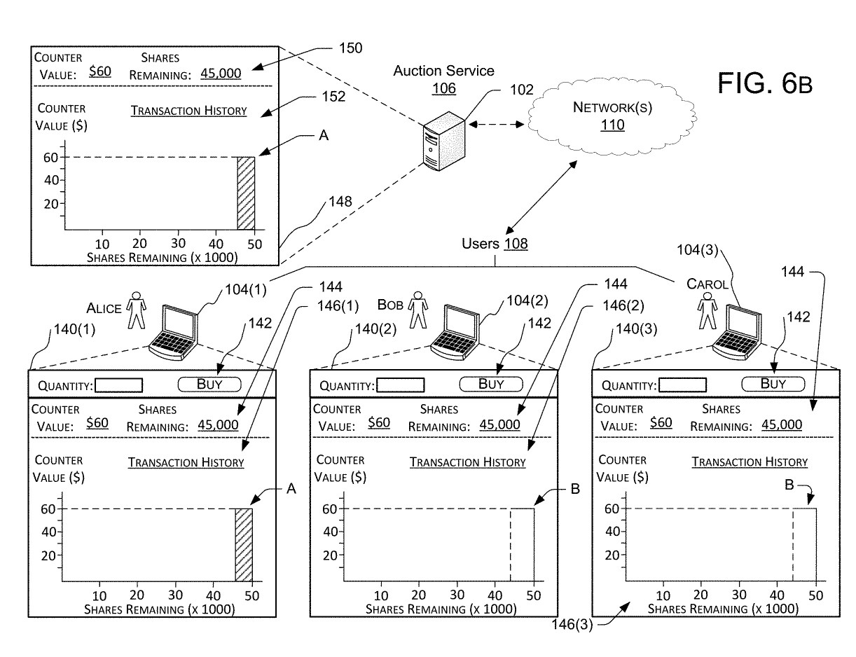

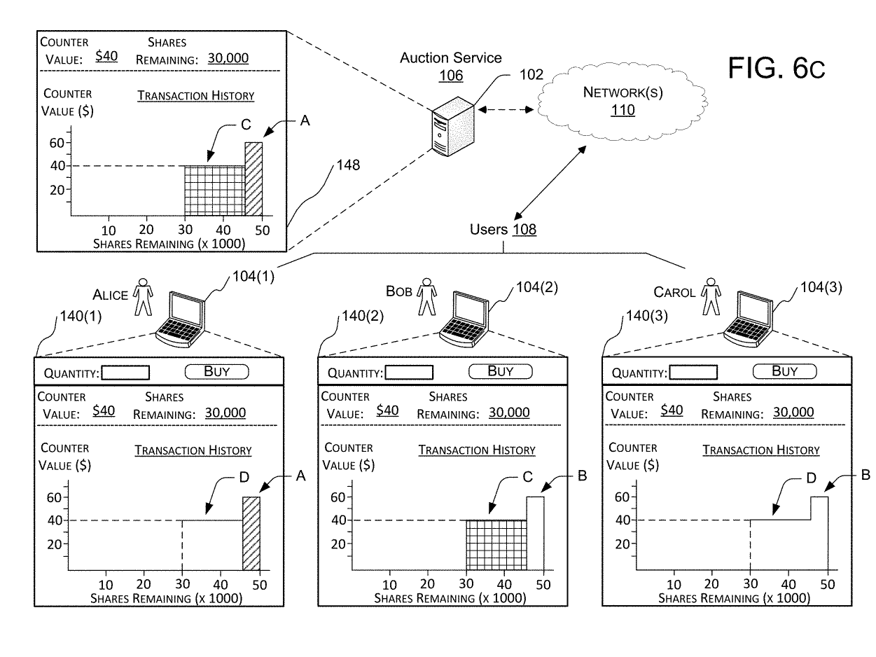

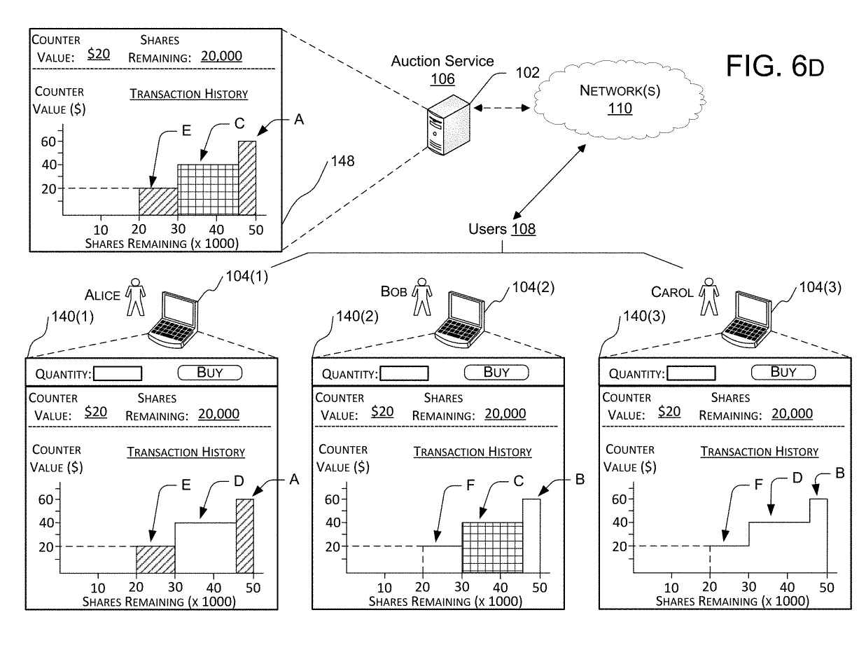

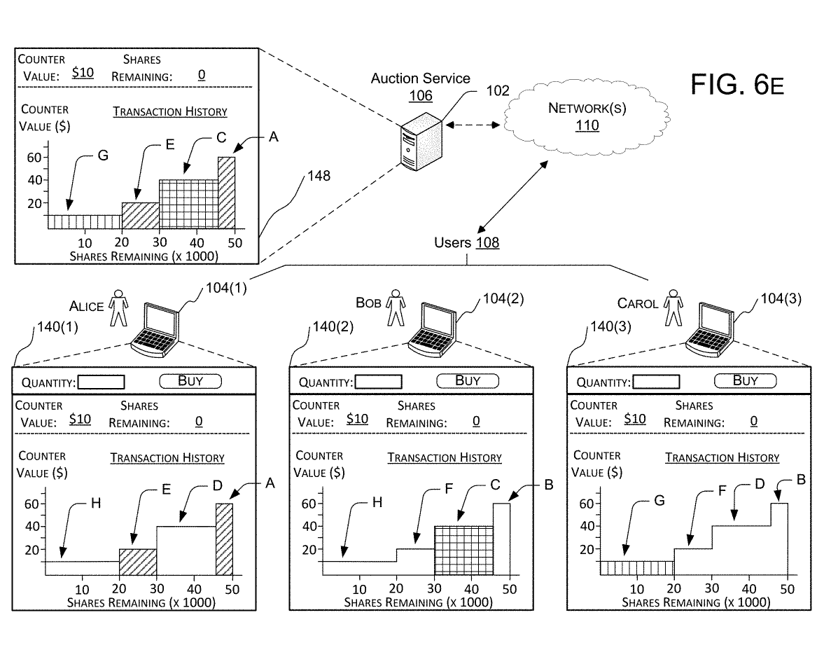

FIG. 6A is a flow diagram that illustrates an example method 600 for operating and/or otherwise facilitating an example one-sided auction for the purchase of a plurality of substantially indistinguishable items. The example auction associated with the method 600 may comprise either a centralized auction or a decentralized auction. Accordingly, the auction associated with the method 600 may be performed, at least in part, using either the system illustrated in FIG. 1, and/or one or more components thereof, or the system illustrated in FIG. 4, and/or one or more components thereof. In particular, the example functions shown in FIG. 6A and other flow diagrams and example processes herein can be implemented on or otherwise embodied in one or more computing device(s) 102, 104, or 402. For example, in a centralized auction, such as an auction performed and/or facilitated by the system shown in environment 100, the functions shown in FIG. 6A and other flow diagrams and example processes herein can be implemented using software running on one or more of the computing devices 102, 200, 104, 300. Alternatively, in a decentralized auction, such as an auction performed and/or facilitated by the system shown in environment 400, one or more of the functions of method 600 may be performed by one or more of the computing devices 402 500, and the computing devices 102, 200 may be omitted.

The order in which the operations are described in each example flow diagram or method is not intended to be construed as a limitation, and any number of the described operations can be combined in any order and/or in parallel to implement each method. Moreover, the operations in each of FIGS. 6A-6E can be implemented in hardware, software, and/or a combination thereof. In the context of software, the operations represent computer-executable instructions that, when executed by one or more processors, cause one or more processors to perform the recited operations. In the context of hardware, the operations represent logic functions implemented in circuitry, e.g., datapath-control and finite-state-machine sequencing functions.

In some examples, at block 602 one or more bidders wishing to participate in an auction may provide information associated with the bidder and/or otherwise identifying at least one of the bidder and a computing device 300, 500 of the bidder. For example, the one or more bidders may enter such information via the electronic device 300, 500. In some examples, the dashboard module 322 of the user computing device 300 may receive such information from a bidder, and the dashboard module 322 may provide such information to the communication module 222 of the auction service computing device 200. Alternatively, in a decentralized auction, the communication module 522 of the computing device 500 may receive such information from the bidder. Such information may include, for example, a name, address, Social Security Number, Employer Identification Number, bank account number, telephone number, email address, and/or other information noted herein describing the bidder and/or the computing device 300, 500 of the bidder. Such information may be provided by the bidder in order to, for example, register for the auction.

Further, at block 602, one or more of the receivers wishing to provide an item for auction may also provide information. Such information may be associated with the receiver and/or with a plurality of substantially indistinguishable items being provided by the receiver for the auction. For example, the one or more receivers may enter such information via a respective electronic device 300, 500 of the receiver. In some examples, the dashboard module 322 of the user computing device 300 may receive such information from a receiver, and the dashboard module 322 may provide such information to the communication module 222 of the auction service computing device 200. Alternatively, in a decentralized auction, the communication module 522 of the computing device 500 may receive such information from the receiver. Such information may include information describing a plurality of substantially indistinguishable items being provided by the receiver for the auction. As noted above, such substantially indistinguishable items may comprise any divisible goods or other items having substantially the same configuration, physical characteristics, and/or value (e.g., shares, commodities, offices in an office space, debt, raffle tickets, tokens, etc.). Accordingly, in examples in which the plurality of substantially indistinguishable items comprises a block of stock shares, such information may include the company or other entity to which the shares correspond, the number of shares being offered in the auction, the class of shares (e.g., voting, non-voting, etc.), the current stock price as listed on a public market exchange (e.g., the New York Stock Exchange), a per-share reserve price associated with the block of shares, etc. Alternatively, in another example in which the plurality of substantially indistinguishable items comprises a commodity such as wheat, sugar, coffee, cocoa, gold, or oil, such information may include the type of commodity (e.g., wheat, sugar, coffee, etc.), the amount of the commodity being offered in the auction, a reserve price per unit of the commodity, a country/state/region/farm/mine of origin, etc. Such information may also include any other information descriptive of the particular item or items provided for auction by the receiver.

At block 604, the method may include generating a series of decreasing counter values. Such counter values may comprise respective proxies for the strike price, matching price, and/or other per-item price corresponding to the plurality of substantially indistinguishable items provided for sale during the auction. For example, during the auction the counter module 226 of the auction service computing device 200 may generate an initial counter value, and may continue to generate a series of counter values that decrease over time during the auction. Alternatively, in a decentralized auction the series of decreasing counter values may be generated by the counter module 526 of the computing device 500 of the bidder and/or the receiver at block 610.

In some examples, the counter values generated at block 604 may decrease at a substantially constant rate. Alternatively, the counter values generated at block 604 may decrease at a variable rate. Such a rate may vary depending on, for example, the difference between the counter value when a first bid is received and a reserve price submitted by the receiver. For example, if the difference (e.g., a spread value) between a bid and such a reserve price is equal to $200, and the particular counter value active when the bid is received is equal to $500, the counter values generated by the counter module 226, 526 may decrease at a relatively fast rate. However, as the counter value decreases such that it approaches the spread value of $200 and/or as the counter value approaches the reserve price, counter module 226, 526 may decrease the rate at which the counter value decreases until the counter value is equal to either the spread value or the reserve price.

At block 606, the method may include sending, transferring, and/or otherwise providing various information to the bidders participating in the auction. For example, during a centralized auction the communication module 222 of the computing device 102 may provide one or more of the decreasing counter values generated at block 604 to the respective computing devices 102 of the bidders participating in the auction. At block 606, the communication module may also provide, among other things, the current counter value, the number of the substantially indistinguishable items currently remaining and/or otherwise available in the auction, the total amount of money or other currency already spent by the particular bidder during the current auction, a transaction history of the particular bidder, and/or any of the other information described herein with respect to, for example, the dashboard 140 (FIG. 1). Alternatively, in a decentralized auction the counter module 526, dashboard module 532, and/or the user interface 506 may provide such information to the bidder. In such auctions, such information may include, for example, any of the information described above with respect to the example dashboard 420 (FIG. 4).

At block 608, the method may include receiving a bid for a particular quantity of the substantially indistinguishable items from at least one bidder of a plurality of bidders participating in the auction. For example, the bidder may enter such a bid using the dashboard module 322 of the auction application 302 operable on the user computing device 300. The communications interface 318 may then provide the bid to the communication module 222 of the auction service computing device 200. Alternatively, in a decentralized auction the bidder may enter such a bid using the dashboard modules 532 operable on the computing device 500 being used by the bidder. At block 608, the bid may be received during the auction, and the bid may comprise the particular quantity of the substantially indistinguishable items that the bidder wishes to purchase at the particular counter value that is active when the bid was received (e.g., at block 608).

At block 610, the method may include matching the bidder and the particular quantity of the substantially indistinguishable items that the bidder wishes to purchase at least partially in response to the bid received at block 608. In example embodiments, the matching module 228 may match the bidder and the particular quantity at block 610 using the information received at block 602. Such information may identify the bidder and/or the computing device 104, 402 of the bidder, and the matching module 228 may use such information to link and/or otherwise associate the bid with bidder and/or the computing device 104, 402 for accounting and/or other auction-related purposes at block 610. For example, during the auction the matching module 228 of the auction service computing device 200 may monitor the series of decreasing counter values generated by the counter module 226, and may link a particular bid received at block 608 with the corresponding counter value that is active when the bid was received. As a result, the per-item purchase price for the quantity of substantially indistinguishable items identified in the bid will be the corresponding counter value identified by the matching module 228. Alternatively, in a decentralized auction the matching module 528 of the computing device 500 may monitor the series of decreasing counter values generated by the counter module 526, and may link a particular bid received at block 608 with the corresponding counter value that is active when the bid was received. As a result, the per-item purchase price for the quantity of substantially indistinguishable items identified in the bid will be the corresponding counter value identified by the matching module 528. In some examples, such matching may include providing an electronic message or other notification to the bidder and/or to the receiver associated with the plurality of substantially indistinguishable items.

At block 612, the method may further include removing the particular quantity of substantially indistinguishable items, identified in the bid received at block 608, from the auction based at least partly on the matching described above with respect to block 610. For example, the matching module 228, 528 may allocate the particular quantity of substantially indistinguishable items to the bidder providing the bid at block 608, and the particular quantity of substantially indistinguishable items may no longer be visible and/or otherwise available to any of the other bidders participating in the auction. As noted above, the particular bidder providing the bid received at block 608 may remain in the auction even after the particular quantity of substantially indistinguishable items are removed from the auction at block 612.

In such examples, the auction may continue until, for example, all of the substantially indistinguishable items provided by the receiver have been matched with corresponding bidders, until the counter value has decreased to a value less than or equal to a reserve price specified by the receiver, or until the counter value reaches a predetermined threshold value such as zero. Accordingly, at block 614, the method may include determining a number of the substantially indistinguishable items currently remaining in the auction. For example, at block 614 the matching module 228, 528 may calculate or otherwise determine a difference between the quantity of substantially indistinguishable items originally provided by the receiver and the quantity of items matched to the bidder at block 610, and the difference may comprise the number of the substantially indistinguishable items remaining in the auction. It is understood that, in some examples, such a difference may also be determined at block 614 between a cumulative and or total number of substantially indistinguishable items purchased by the bidders participating in the auction and the total number of substantially indistinguishable items provided by the receiver. In some examples, at least one of the operations described above with respect to blocks 610, 612, and 614 may be performed at least partially in response to receiving the bid at block 608.

At block 616, the method may include sending, transferring and/or otherwise providing various additional information to the bidders participating in the auction. For example, at block 616, during a centralized auction the communication module 222 of the computing device 102 may provide one or more additional decreasing counter values generated at block 604 to the respective computing devices 102 of the bidders participating in the auction. At block 616, the communication module 222 may also provide, among other things, the current counter value, the number of the substantially indistinguishable items currently remaining and/or otherwise available in the auction (determined at block 614) to the respective computing devices of each of the bidders. At block 616, the communication module 22 may also provide, to one or more particular bidders, the total amount of money or other currency already spent by the particular bidder during the current auction, a transaction history of the particular bidder, and/or any of the other information described herein with respect to, for example, the dashboard 140 (FIG. 1). Alternatively, at block 616, in a decentralized auction the counter module 526, dashboard module 532, and/or the user interface 506 may provide such additional information to the bidder. In such auctions, such additional information provided at block 616 may include, for example, any of the information described above with respect to the example dashboard 420 (FIG. 4). Further, it is understood that in example auctions the computing device 102 may provide at least one of the total number of items remaining in the auction, the total number of items purchased by a bidder at a particular counter value, or the total number of shares offered by the receiver in the auction. In such examples, the computing device 104 of the bidder receiving such information may calculate or otherwise determine the number of remaining items, at block 614, based on such information.

At block 618, the method may include determining whether any of the substantially indistinguishable items are remaining in the auction. For example, at block 614 the matching module 228, 528 may monitor and/or otherwise track the number of remaining items determined at block 614. At block 618, if a quantity of substantially indistinguishable items remaining in the auction is greater than zero (block 618—Yes), control may proceed to block 608, and the auction may continue. Alternatively, if none of the substantially indistinguishable items are remaining in the auction (block 618—No), control may proceed to block 620 and the auction may end.

One or more of the blocks 602-620 will now be described in greater detail below with respect to FIGS. 6B-6E. As shown in FIG. 6B, any of the information described above with respect to block 602 may be provided by the bidder or the receiver via a dashboard and/or other user interface operable on the respective computing device being utilized by the bidder or the receiver. Such information may be provided by the bidder or the receiver, and received as described above with respect to block 602, before and/or during the auction. For example, one or more bidders (e.g., Alice, Bob, and Carla) may provide information at block 602 via respective dashboards 140(1), 140(2), 140(3) generated and/or otherwise provided by the dashboard module 322 of the corresponding respective computing devices 104(1), 104(2), 104(3) utilized by the bidders. Such information may be transferred to the computing device 102 of the auction service 106 via the network 110. Alternatively, in a decentralized auction one or more of the bidders (e.g., Alice, Bob, and Carla) may provide such information at block 602 via dashboards 140(1), 140(2), 140(3) generated and/or otherwise provided by the dashboard module 532 of the corresponding respective computing devices 104(1), 104(2), 104(3) utilized by the bidders.

In any of the example embodiments described herein, such dashboards 140(1), 140(2), 140(3) may include a variety of tools 142 operable to enable the bidder to provide information, request information, view information, and/or perform one or more additional functions associated with the auction. For example, the dashboards 140(1), 140(2), 140(3) may include a search tool, a query box, a tool enabling the bidder to request further information with respect to the plurality of substantially indistinguishable items provided during the auction, and/or any of the other tools 142(1), 142(2), 142(3) described above with respect to the dashboards 140 described with respect to FIG. 1. Such tools 142 may enable the bidder to place and/or change a bid associated with a particular quantity of substantially indistinguishable items available in an auction, to request additional information associated with such items, to, for example, send a message the auction service 106, and/or to perform any other tasks associated with the auction. For example, the various tools 142 illustrated in the dashboards 140(1), 140(2), 140(3) of FIGS. 6B-6E may enable the respective bidders (e.g., Alice, Bob, and Carla) to enter bids and/or otherwise purchase particular respective quantities of the substantially indistinguishable items offered in the auction as described above with respect to block 608. The dashboards 140(1), 140(2), 140(3) may also include information 144 including the current counter value, the number of substantially indistinguishable items currently remaining in the auction, the time until the next decrement or decrease in the current counter value and/or any other information 144 described herein. For example, a series of decreasing counter values may be generated as described above with respect to block 604, and such counter values and/or other information 144 may be provided to the bidders via the dashboards 140(1), 140(2), 140(3) throughout the auction, as described with respect to blocks 606, 616.

The dashboards 140(1), 140(2), 140(3) may also provide a plurality of additional information 146(1), 146(2), 146(3) to the respective bidders during the auction. For example, such additional information 146(1), 146(2), 146(3) may include among other things, a transaction history that is specific to the respective bidder. In some examples, the transaction history may indicate the particular quantity of items previously bid on and/or otherwise purchased by the bidder, the particular counter value at which the bidder was matched with the quantity of items, and an identifier that uniquely identifies the bidder. For example, as shown in the dashboard 140(1) associated with an example ongoing auction, Alice has purchased a quantity of 5,000 shares at a counter value or per-share price of $60. In particular, the width of an identifier A along the X-axis of the illustrated transaction history indicates the particular quantity (5,000) of items/shares previously bid on and/or otherwise purchased by Alice, and the height of the identifier A along the Y-axis of the illustrated transaction history indicates the particular counter value ($60) at which the particular quantity of items/shares were purchased. Further, the identifier A may be color coded, shaded, hatched, labeled, and/or otherwise marked so as to uniquely identify Alice and/or to distinguish transactions made by Alice from transactions made by other bidders participating in the present auction and represented in the transaction history.

The various transaction histories provided by the respective dashboards 140(1), 140(2), 140(3) may also indicate quantities of items previously purchased by other bidders in the auction, as well as the respective counter values at which the other bidders were matched with the respective quantities of items. In some examples, however, the identity of the other bidders participating in the auction may not be shared with the respective bidders. For example, while the transaction history provided to Alice in the dashboard 140(1) may include the identifier A that uniquely identifies Alice, the transaction histories provided to Bob and Carol at this stage of the ongoing auction may omit the Alice-specific identifier A, and instead, may include a generic identifier B that does not identify Alice to Bob or Carol. Instead, the generic identifier B may indicate the particular quantity (5,000) of items/shares previously bid on and/or otherwise purchased during the ongoing auction, as well as the particular counter value ($60) at which the particular quantity of items/shares were purchased, without identifying Alice. Any such additional information 146 may be provided to the individual bidders at block 606 and/or block 616.

Further, in example centralized auctions a dashboard module of the computing device 102 may provide a dashboard 148 to an auctioneer and/or other user of the computing device 102 and, as illustrated in FIG. 6B, such a dashboard 148 may provide information 150, 152 including a global transaction history identifying each of the bidders participating in the ongoing auction. As will be described below, the transaction history included in the dashboard 148 may include identifiers corresponding to each of the purchases and/or matches made during the auction, and the identifiers included in the dashboard 148 may uniquely identify each of the bidders (e.g., Alice, Bob, and Carol) corresponding to the respective purchases and/or matches. For example, as shown in FIG. 6B, at this stage of the example auction the example dashboard 148 includes the identifier A uniquely identifying Alice, and indicating the particular quantity (5,000) of items/shares previously bid on and/or otherwise purchased by Alice as well as the particular counter value ($60) at which the particular quantity of items/shares were purchased. Further, as shown in each of the dashboards 140, 148 illustrated in FIG. 6B, the current counter value (generated at block 604) is $60 per share, and there are a total of 45,000 shares currently remaining and/or otherwise available in the ongoing auction. The number of remaining shares provided by the respective dashboards 140(1), 140(2), 140(3) may be determined as described above with respect to block 614. Additionally, the matching of bidders with a respective quantity of substantially indistinguishable items described above with respect to block 610, and the removal of the respective quantity of substantially indistinguishable items described above with respect to block 612 may be reflected in both the information 144 and the transaction history provided by the respective dashboards 140(1), 140(2), 140(3) shown in FIGS. 6B-6E.

Additionally, in any of the example auctions described herein, one or more encryption modules of the present disclosure may be configured to generate encrypted information by encrypting information received from at least one of the bidder, the receiver, and the auction service. The encryption module may also store encrypted information within the computer-readable media and/or other memory of the electronic device on which the encryption module is operable. For example, any of the information received at block 602, any information provided at blocks 606, 616 by way of one of the dashboards described herein, and/or any of the bids received at block 608 may be encrypted by the encryption module 224 of the computing device 102 upon receipt thereof. Such a computing device 102 may be in communication with the computing device 104(2) of the receiver and with the computing device 104(1) of the bidder. Alternatively, in a decentralized auction such information may be encrypted by the encryption module 524. By encrypting information in this way, the encryption modules 224, 524 described herein may provide increased security with respect to information that is shared during the auction. Additionally, in any of the auctions described herein, the encryption modules 224, 524 and/or the compression modules 232, 534 may modify the various information, messages, requests, bids, asks, and/or other auction content described herein prior to transmitting such content using via the network 110. For example, the compression modules 232, 534 may compress, zip, and/or otherwise modify such auction content, thereby generating modified auction content prior to transmission. Such modified auction content may have a reduced size, reduced bandwidth requirements, reduced memory requirement, and/or other such characteristic. As a result, such modified auction content may be transmitted across the network 110 more quickly, may reduce the bandwidth and/or other system resources required for transmission, and may reduce the memory requirements at one or more of the computing devices 200, 102, 104 associated with storing such content. As a result, generation and utilization of such modified auction content by the encryption modules 224, 524 and/or the compression modules 232, 534 may improve the efficiency of the systems described herein, and/or of the auction facilitated by such systems.

FIG. 6C illustrates information provided during another stage of the ongoing auction described with respect to FIG. 6B. As illustrated by each of the dashboards 140, 148 illustrated in FIG. 6C, the current counter value has decreased to $40 per share. Additionally, due to a purchase made by Bob, there are currently 30,000 shares remaining and/or otherwise available in the auction. In particular, as shown in the dashboard 140(2), Bob has purchased a quantity of 15,000 shares at a counter value or per-share price of $40. In particular, the width of an identifier C along the X-axis of the illustrated transaction history indicates the particular quantity (15,000) of items/shares previously bid on and/or otherwise purchased by Bob, and the height of the identifier C along the Y-axis of the illustrated transaction history indicates the particular counter value ($40) at which the particular quantity of items/shares were purchased. Further, the identifier C may be color coded, shaded, hatched, labeled, and/or otherwise marked so as to uniquely identify Bob and/or to distinguish transactions made by Bob from transactions made by other bidders (e.g., Alice) participating in the present auction and represented in the transaction history.

Additionally, while the transaction history provided to Bob in the dashboard 140(2) may include the identifier C that uniquely identifies Bob, the transaction histories provided to Alice and Carol at this stage of the ongoing auction may omit the Bob-specific identifier C, and instead, may include a generic identifier D that does not identify Bob to Alice or Carol. Instead, the generic identifier D may indicate the particular quantity (15,000) of items/shares previously bid on and/or otherwise purchased by Bob during the ongoing auction, as well as the particular counter value ($40) at which Bob purchased the particular quantity of items/shares, without identifying Bob. Any such information 144, 146 may be provided to the individual bidders at block 606 and/or block 616.

Further, in example centralized auctions the dashboard 148 generated by the computing device 102 may include identifiers corresponding to each of the purchases and/or matches made during the auction, and the identifiers included in the dashboard 148 may uniquely identify each of the bidders corresponding to the respective purchases and/or matches. For example, as shown in FIG. 6C, at this stage of the example auction the example dashboard 148 includes the identifier A uniquely identifying Alice, and indicating the particular quantity (5,000) of items/shares previously bid on and/or otherwise purchased by Alice as well as the particular counter value ($60) at which Alice purchased the particular quantity of items/shares. The dashboard 148 also includes the identifier C uniquely identifying Bob, and indicating the particular quantity (15,000) of items/shares previously bid on and/or otherwise purchased by Bob as well as the particular counter value ($40) at which Bob purchased the particular quantity of items/shares.

FIG. 6D illustrates information provided during still another stage of the ongoing auction described with respect to FIG. 6B. As illustrated by each of the dashboards 140, 148 illustrated in FIG. 6D, the current counter value has decreased to $20 per share. Additionally, due to an additional purchase made by Alice, there are currently 20,000 shares remaining and/or otherwise available in the auction. In particular, as shown in the dashboard 140(1), Alice has purchased a quantity of 10,000 shares at a counter value or per-share price of $20. In particular, the width of an identifier E along the X-axis of the illustrated transaction history indicates the particular quantity (10,000) of items/shares previously bid on and/or otherwise purchased by Alice, and the height of the identifier E along the Y-axis of the illustrated transaction history indicates the particular counter value ($20) at which the particular quantity of items/shares were purchased. Further, the identifier E may be color coded, shaded, hatched, labeled, and/or otherwise marked so as to uniquely identify Alice and/or to distinguish transactions made by Alice from transactions made by other bidders (e.g., Bob) participating in the present auction and represented in the transaction history. As shown in FIG. 6D, the identifiers A and E may have the same color, shading, hatching, labeling, and/or other marking so as to uniquely identify Alice and/or to distinguish transactions made by Alice from those made by other bidders in the present auction.

Additionally, while the transaction history provided to Alice in the dashboard 140(1) at this stage of the auction may include the identifiers A and E that uniquely identify Alice, the transaction histories provided to Bob and Carol at this stage of the ongoing auction may omit the Alice-specific identifiers A and E. Instead, the transaction histories provided to Bob and Carol at this stage of the auction may include another generic identifier F that does not identify Alice to Bob or Carol. Instead, the generic identifier F may indicate the particular quantity (10,000) of items/shares previously bid on and/or otherwise purchased by Alice during the ongoing auction, as well as the particular counter value ($20) at which Alice purchased the particular quantity of items/shares, without identifying Alice. Any such information 144, 146 may be provided to the individual bidders at block 606 and/or block 616.

Further, as shown in FIG. 6D, at this stage of the example auction an example dashboard 148 may include the identifier A uniquely identifying Alice, and indicating the particular quantity (5,000) of items/shares previously bid on and/or otherwise purchased by Alice as well as the particular counter value ($60) at which Alice purchased the particular quantity of items/shares. The dashboard 148 may also include the identifier C uniquely identifying Bob, and indicating the particular quantity (15,000) of items/shares previously bid on and/or otherwise purchased by Bob as well as the particular counter value ($40) at which Bob purchased the particular quantity of items/shares. Such an example dashboard 148 may further include the identifier E uniquely identifying Alice, and indicating the particular quantity (10,000) of items/shares previously bid on and/or otherwise purchased by Alice as well as the particular counter value ($20) at which Alice purchased the particular quantity of items/shares.

FIG. 6E illustrates information provided during yet another stage of the auction described with respect to FIG. 6B. As illustrated by each of the dashboards 140, 148 illustrated in FIG. 6E, the current counter value has decreased to $10 per share. Additionally, due to a purchase made by Carol, there are currently 0 shares remaining and/or otherwise available in the auction, and accordingly, the auction may now be closed. As shown in the dashboard 140(3), Carol has purchased the remaining quantity of 20,000 shares at a counter value or per-share price of $10. In particular, the width of an identifier G along the X-axis of the illustrated transaction history indicates the particular quantity (20,000) of items/shares previously bid on and/or otherwise purchased by Carol, and the height of the identifier G along the Y-axis of the illustrated transaction history indicates the particular counter value ($10) at which the particular quantity of items/shares were purchased. Further, the identifier G may be color coded, shaded, hatched, labeled, and/or otherwise marked so as to uniquely identify Carol and/or to distinguish transactions made by Carol from transactions made by other bidders (e.g., Bob and Alice) participating in the present auction and represented in the transaction history.

Additionally, while the transaction history provided to Carol in the dashboard 140(3) at this stage of the auction may include the identifier G that uniquely identifies Carol, the transaction histories provided to Bob and Alice at this stage of the ongoing auction may omit the Carol-specific identifier G. Instead, the transaction histories provided to Bob and Alice at this stage of the auction may include another generic identifier H that does not identify Carol to Bob or Alice. Instead, the generic identifier H may indicate the particular quantity (20,000) of items/shares previously bid on and/or otherwise purchased by Carol during the auction, as well as the particular counter value ($10) at which Carol purchased the particular quantity of items/shares, without identifying Carol. Any such information 144, 146 may be provided to the individual bidders at block 606 and/or block 616.

Further, as shown in FIG. 6E, at this stage of the example auction an example dashboard 148 may include the identifier A uniquely identifying Alice, and indicating the particular quantity (5,000) of items/shares previously bid on and/or otherwise purchased by Alice as well as the particular counter value ($60) at which Alice purchased the particular quantity of items/shares. The dashboard 148 may also include the identifier C uniquely identifying Bob, and indicating the particular quantity (15,000) of items/shares previously bid on and/or otherwise purchased by Bob as well as the particular counter value ($40) at which Bob purchased the particular quantity of items/shares. Such an example dashboard 148 may further include the identifier E uniquely identifying Alice, and indicating the particular quantity (10,000) of items/shares previously bid on and/or otherwise purchased by Alice as well as the particular counter value ($20) at which Alice purchased the particular quantity of items/shares. The dashboard 148 may also include the identifier G uniquely identifying Carol, and indicating the particular quantity (20,000) of items/shares previously bid on and/or otherwise purchased by Carol as well as the particular counter value ($10) at which Carol purchased the particular quantity of items/shares. Because the auctions described herein are descending in nature, the dashboard 148 may comprise a chronological visual representation of the transactions that occurred during the auction.

As shown in FIGS. 6B-6E, the bidders Alice, Bob, and Carol may remain in the ongoing auction until there are no further substantially indistinguishable items remaining in the auction, until the counter value has decreased to a value less than or equal to a predetermined reserve price, or until another predetermined stop condition has been met. Additionally, as part of any of the methods described herein, once a match has been made as described above with respect to block 610, one or more of the computing devices may determine an amount required for the bidder to pay to the receiver and/or the auction service 106 for the particular quantity of substantially indistinguishable items purchased by the respective bidder. Additionally, such methods may include providing a payment request to the bidder. For example, with reference to FIG. 6B and blocks 608-612, once Alice enters a bid and/or otherwise purchases a quantity of 5,000 shares at a per-item counter value of $60, the payment module 230 of the computing device 102 may determine an amount due ($30,000) by multiplying the particular quantity (5,000) by the counter value ($60) that was active when the bid from Alice was received at block 608. The computing device 102 may generate a payment request that includes the amount due, and may provide the payment request to Alice via the dashboard 140(1). For example, the payment module 230 may provide such a payment request to Alice using, for example, communication module 222. In particular, the communication module 222 of the computing device 102 may send such a payment request to the computing device 104(1) being utilized by Alice, and the payment module 324 of the computing device 104(1) may assist Alice in providing a corresponding payment to the receiver and/or to the auction service 106, such as by an electronic fund transfer, an electronic check, and/or any other form of electronic payment. Such an electronic payment may be completed and/or otherwise facilitated based on further input from Alice via the dashboard 140(1). Alternatively, in a decentralized auction one or more of the methods described above with respect to, for example, determining an amount due, providing a payment request, and/or providing a corresponding payment may be performed by the payment module 530, communication module 522, and/or other modules operable on at least one of the computing devices 104(1), 104(2), 104(3).

As noted above, the example auctions described herein with respect to FIGS. 6A-6E may be governed by a series of descending counter values. As a result, in such auctions relatively high-value bids/purchases occur before relatively low-value bids/purchases. Accordingly, such descending price auctions result in more economically efficient outcomes than conventional auctions. Additionally, due to the processes described with respect to FIGS. 6A-6E, the example auctions of the present disclosure minimize the number of bidder interactions needed to conduct the auction as compared to traditional public ascending price auctions and/or other traditional auction formats. For example, while traditional ascending price auctions require each bidder to confirm, at each counter value, whether they are participating in the auction and to state a particular quantity of items he or she wants to purchase (even if the particular quantity is zero at the current counter value), the example auctions of the present disclosure only require bidders to place bids when the counter value decreases to a per-item value at which the respective bidder wants to bid on a particular quantity of substantially indistinguishable items. Since the example auctions described with respect to FIGS. 6A-6E only require individual bidders to provide an input, such as via the respective dashboards 140(1), 140(2), 140(3) when the bidder wishes to place a bid, such auctions reduce the overall amount of information transmitted over the network 110 over the course of the auction relative to traditional ascending price auctions. Consequently, the example auctions of the present disclosure also reduce the bandwidth and/or other network resources being utilized, as well as the amount of memory, processing unit, and/or other computing device resources required for storing and/or processing such information at the auction service computing device 102 and/or at the computing device 104(1), 104(2), 104(3) of each respective bidder.

Additionally, in order to facilitate the example auctions described herein with respect to FIGS. 6A-6E, the example computing devices 102, 104 of the present disclosure need only generate and/or determine a current counter value (e.g., block 604), a current number of items remaining in the auction (e.g., block 614), and/or the time at which to decrement and/or otherwise decrease the counter value. Computing devices used to facilitate traditional ascending price auctions, on the other hand, are required to generate and/or determine the above parameters as well as a number of additional parameters at each counter value, such as the number of shares demanded by each bidder. Thus, example auctions of the present disclosure taking place in centralized or decentralized environments require reduced levels of computational complexity. For example, in centralized environments of the present disclosure, such reduced complexity levels may advantageously reduce the resources requirements associated with the network 110, the processing units 208, 308, and/or the computer-readable media 210, 310 relative to traditional ascending price auctions. Such reduced complexity levels can be particularly advantageous in decentralized environments, such as the environment described with respect to FIG. 4, and may enable peer-to-peer applications operating on the respective computing devices 402 of the individual users/bidders 404 in such environments to reach mutual agreement in less time and utilizing reduced resources associated with the network 110, the processing units 408, and/or the computer-readable media 410. Accordingly, the example embodiments described herein provide and/or result in meaningful improvements in the performance of the various networks 110 and computing devices 102, 104, 402.

### Example Clauses

A: A system comprising: one or more processing units; and computer-readable media operably connected to the one or more processing units, the computer-readable media storing a plurality of modules that, when executed by the one or more processing units, cause the one or more processing units to perform operations comprising: generating, by a counter module, a series of decreasing counter values during an auction of a plurality of substantially indistinguishable items; providing, by a communication module, the series of decreasing counter values to a computing device of a bidder participating in the auction; receiving, by the communication module, a bid for a first quantity of the substantially indistinguishable items from the computing device of the bidder at a first counter value of the series of decreasing counter values; determining, by a matching module, a remaining quantity of the substantially indistinguishable items remaining in the auction after removal of the first quantity of the substantially indistinguishable items from the auction; and providing, by the communication module, at least one of the remaining quantity or the first quantity to the computing device of the bidder, wherein the bidder remains an active participant in the auction.

B: The system of clause A, the operations further comprising: determining, by a payment module, an amount to be paid by the bidder for the first quantity of the substantially indistinguishable items; generating, by the payment module, a payment request comprising the amount to be paid; and providing, by the communication module, the payment request to the computing device of the bidder.

C: The system of clause A or B, further including an encryption module which, when executed, encrypts information received by the communication module about the bidder or the computing device of the bidder, thereby generating encrypted information, the communication module providing the at least one of the first quantity or the remaining quantity, and at least part of the encrypted information, to a computing device of an additional bidder participating in the auction.

D: The system of clause A, B, or C, wherein, further comprising instructions stored in the computer-readable media that, when executed, cause presentation of a user interface configured to display the remaining quantity, and a current counter value of the series of decreasing counter values, wherein the current counter value comprises a per-item price associated with the bid.

E: The system of clause D, wherein, the user interface is configured to display the remaining quantity and the current counter value with information, the information comprising: the first quantity of the substantially indistinguishable items, a particular counter value of the series of decreasing counter values at which the bid was received for the first quantity of the substantially indistinguishable items, and an identifier in association with the information, the identifier uniquely identifying the bidder.

F: The system of clause E, wherein, wherein the user interface is further configured to display the information with additional information, the additional information comprising: a second quantity of the substantially indistinguishable items purchased by an additional bidder, an additional counter value at which the additional bidder purchased the second quantity, and an additional identifier in association with the additional information, the additional identifier uniquely identifying the additional bidder.

G: A method, comprising: generating a series of decreasing counter values during an auction associated with a plurality of substantially indistinguishable items; providing the series of decreasing counter values to respective computing devices of a plurality of bidders participating in the auction; receiving a bid for a first quantity of the substantially indistinguishable items from a computing device of a bidder of the plurality of bidders and at a first counter value of the series of decreasing counter values, wherein the bid is received via a network to which the computing device of the bidder is connected; at least partly in response to receiving the bid, determining a remaining quantity of the substantially indistinguishable items remaining in the auction after removing the first quantity of the substantially indistinguishable items from the auction; and providing at least one of the remaining quantity or the first quantity to the respective computing devices of the plurality of bidders via the network.

H: The method of clause G, further including: receiving a request for information associated with the plurality of substantially indistinguishable items from the computing device of the bidder; and at least partly in response to receiving the request, prior to receiving the bid, and via the network, providing the computing device of the bidder with access to information associated with the plurality of substantially indistinguishable items.

I: The method of clause G or H, wherein the generating is performed by at least one of: the computing device of the bidder, or an auction service computing device, different from the computing device of the bidder, in communication with the respective computing devices of the plurality of bidders via the network.

J: The method of clause G, H, or I, further comprising receiving an additional bid from the bidder after receiving the first bid for the first quantity of the substantially indistinguishable items.

K: The method of clause G, H, I, or J, wherein the first counter value is a counter value of the series of decreasing counter values that is active when the bid is received.

L: The method of clause G, H, I, J, or K, wherein the bid comprises a first bid, the method further comprising receiving a second bid for a second quantity of the substantially indistinguishable items, wherein: the first bid is received when the first counter value of the series of decreasing counter values is active, the second bid is received from the computing device of the bidder, and the second bid is received when a second counter value of the series of decreasing counter values is active, the second counter value being lower than the first counter value.

M: The method of clause G, H, I, J, K, or L, further comprising providing information to the respective computing devices of the plurality of bidders via the network, the information indicating: the first quantity, and a particular counter value that is active when the bid is received.

N: The method of clause G, H, I, J, K, L, or M, wherein the information provided to the computing device of the bidder is different from the information provided to an additional computing device of an additional bidder of the plurality of bidders.

O: The method of clause G, H, I, J, K, L, M, or N, wherein the bid comprises an encryption key, the method further comprising authenticating the encryption key and verifying an identity of the bidder based at least partly on the authenticating.

P: A method, comprising: generating a first counter value during an auction associated with a plurality of substantially indistinguishable items; providing the first counter value to: a first computing device of a first bidder participating in the auction, and a second computing device of a second bidder participating in the auction; receiving a bid for a first quantity of the substantially indistinguishable items, at a per-item price equal to the first counter value, from the computing device of the first bidder; determining a remaining quantity of the substantially indistinguishable items remaining in the auction after removing the first quantity of the substantially indistinguishable items from the auction; generating a second counter value; and providing information to the first and second computing devices, the information comprising: the remaining quantity, and the second counter value.

Q: The method of clause P, wherein: the first and second counter values are generated by a computing device of an auction service in communication with the first and second computing devices via the network, and the second counter value is less than the first counter value.

R: The method of clause P or Q, wherein the first and second computing devices are in communication via a network, and one or more peer-to-peer applications operating on the first and second computing devices: generates the first and second counter values, determines the remaining quantity, causes display of a first transaction history on the first computing device, the first transaction history including a first identifier uniquely identifying the first bidder, and causes display of a second transaction history on the second computing device, the second transaction history including a second identifier different from the first identifier, the second identifier indicating the first quantity and the first counter value.

S: The method of clause P, Q, or R, further comprising: generating encrypted information by encrypting information received from at least one of the first and second computing devices; and storing the encrypted information within computer-readable media of an auction service computing device, wherein the auction service computing device is in communication with the first and second computing devices via a network.

T: The method of clause P, Q, R, or S, wherein the bid comprises a first bid, the method further comprising receiving a second bid for a second quantity of the substantially indistinguishable items from the second computing device, wherein: the first bidder is participating in the auction when the second bid is received, the first bid is received when the first counter value is active, and the second bid is received when the second counter value is active.

U: The method of clause P, Q, R, S or T, wherein the information provided to the first computing device is different from the information provided to the second computing device.

### CONCLUSION

Various systems, environments, and/or methods described herein can permit efficient matching of bidders with respective quantities of substantially indistinguishable items during descending price auctions associated with such items. Due at least in part to each of the example auctions described herein being governed in accordance with a series of descending counter values, such auctions result in relatively high-value matches/purchases taking place before relatively low-value matches/purchases. As a result, example auctions of the present disclosure reduce the amount of time, effort, and other resources that bidders must invest in determining the quality of potential matches, resulting in more economically efficient outcomes than conventional auctions. Additionally, the auctions described herein may be facilitated with minimal computational complexity and with reduced input from the respective bidders, thereby lessening the bandwidth, memory, processing, and/or other resource requirements of the systems described herein. Further, due to the techniques described herein, information associated with such auctions may be transmitted across one or more networks in a more efficient and secure manner, and in a manner that reduces the bandwidth, memory, and/or other resource requirements of the systems described herein. As a result, the methods described herein improve the functionality of such systems.

Although the techniques have been described in language specific to structural features or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more computing device(s) 102, 104, or 200 such as one or more internal or external CPUs or GPUs, and/or one or more pieces of hardware logic such as FPGAs, DSPs, or other types described above.

Conditional language such as, among others, “can,” “could,” “might” or “may,” unless specifically stated otherwise, mean that certain examples include, while other examples do not include, certain features, elements and/or operations. Thus, such conditional language is meant to indicate that certain features, elements and/or operations are permissible but not required for one or more examples. Conjunctive language such as the phrase “at least one of X, Y or Z” and “and/or,” unless specifically stated otherwise, is to be understood to present that an item, term, etc., can be either X, Y, or Z, or a combination thereof.

Any descriptions, elements or blocks in the flow diagrams described herein and/or depicted in the attached figures should be understood as representing modules, segments, or portions of code that include one or more executable instructions for implementing specific logical functions or elements. Many variations and modifications can be made to the above-described examples. All such modifications and variations are intended to be included herein within the scope of this disclosure and protected by the following claims. For instance, the examples described herein include variations in which elements or functions are deleted, or executed out of order from that shown or discussed, including substantially synchronously or in reverse order, depending on the functionality involved as would be understood by those skilled in the art.

What is claimed is:

1. A system comprising:
one or more processing units; and
computer-readable media operably connected to the one or more processing units, the computer-readable media storing a plurality of modules that, when executed by the one or more processing units, cause the one or more processing units to perform operations comprising:
generating, by a counter module, a series of decreasing counter values during an auction of a plurality of substantially indistinguishable items;
providing, by a communication module, the series of decreasing counter values to a computing device of a bidder participating in the auction;
receiving, by the communication module, a bid for a first quantity of the substantially indistinguishable items from the computing device of the bidder at a first counter value of the series of decreasing counter values;
determining, by a matching module, a remaining quantity of the substantially indistinguishable items remaining in the auction after removal of the first quantity of the substantially indistinguishable items from the auction; and
providing, by the communication module, at least one of the remaining quantity or the first quantity to the computing device of the bidder,
wherein the bidder remains an active participant in the auction.

2. The system of claim 1, further including an encryption module which, when executed, encrypts information received by the communication module about the bidder or the computing device of the bidder, thereby generating encrypted information, the communication module providing the at least one of the first quantity or the remaining quantity, and at least part of the encrypted information, to a computing device of an additional bidder participating in the auction.

3. The system of claim 1, further comprising instructions stored in the computer-readable media that, when executed, cause presentation of a user interface configured to display the remaining quantity, and a current counter value of the series of decreasing counter values, wherein the current counter value comprises a per-item price associated with the bid.

4. The system of claim 3, wherein the user interface is configured to display the remaining quantity and the current counter value with information, the information comprising:
the first quantity of the substantially indistinguishable items,
a particular counter value of the series of decreasing counter values at which the bid was received for the first quantity of the substantially indistinguishable items, and
an identifier in association with the information, the identifier uniquely identifying the bidder.

5. The system of claim 4, wherein the user interface is further configured to display the information with additional information, the additional information comprising:
a second quantity of the substantially indistinguishable items purchased by an additional bidder,
an additional counter value at which the additional bidder purchased the second quantity, and
an additional identifier in association with the additional information, the additional identifier uniquely identifying the additional bidder.

6. A method, comprising:
generating a series of decreasing counter values during an auction associated with a plurality of substantially indistinguishable items;
providing the series of decreasing counter values to respective computing devices of a plurality of bidders participating in the auction;
receiving a bid for a first quantity of the substantially indistinguishable items from a computing device of a bidder of the plurality of bidders and at a first counter value of the series of decreasing counter values, wherein the bid is received via a network to which the computing device of the bidder is connected;
at least partly in response to receiving the bid, determining a remaining quantity of the substantially indistinguishable items remaining in the auction after removing the first quantity of the substantially indistinguishable items from the auction; and
providing at least one of the remaining quantity or the first quantity to the respective computing devices of the plurality of bidders via the network.

7. The method of claim 6, further including:
receiving a request for information associated with the plurality of substantially indistinguishable items from the computing device of the bidder; and
at least partly in response to receiving the request, prior to receiving the bid, and via the network, providing the computing device of the bidder with access to information associated with the plurality of substantially indistinguishable items.

8. The method of claim 6, wherein the generating is performed by at least one of:
the computing device of the bidder, or
an auction service computing device, different from the computing device of the bidder, in communication with the respective computing devices of the plurality of bidders via the network.

9. The method of claim 6, further comprising receiving an additional bid from the bidder after receiving the first bid for the first quantity of the substantially indistinguishable items.

10. The method of claim 6, wherein the first counter value is a counter value of the series of decreasing counter values that is active when the bid is received.

11. The method of claim 6, wherein the bid comprises a first bid, the method further comprising receiving a second bid for a second quantity of the substantially indistinguishable items, wherein:
the first bid is received when the first counter value of the series of decreasing counter values is active,
the second bid is received from the computing device of the bidder, and
the second bid is received when a second counter value of the series of decreasing counter values is active, the second counter value being lower than the first counter value.

12. The method of claim 6, further comprising providing information to the respective computing devices of the plurality of bidders via the network, the information indicating:
the first quantity, and
a particular counter value that is active when the bid is received.

13. The method of claim 12, wherein the information provided to the computing device of the bidder is different from the information provided to an additional computing device of an additional bidder of the plurality of bidders.

14. The method of claim 6, wherein the bid comprises an encryption key, the method further comprising authenticating the encryption key and verifying an identity of the bidder based at least partly on the authenticating.

15. A method, comprising:
generating a first counter value during an auction associated with a plurality of substantially indistinguishable items;
providing the first counter value to:
a first computing device of a first bidder participating in the auction, and
a second computing device of a second bidder participating in the auction;
receiving a bid for a first quantity of the substantially indistinguishable items, at a per-item price equal to the first counter value, from the computing device of the first bidder;
determining a remaining quantity of the substantially indistinguishable items remaining in the auction after removing the first quantity of the substantially indistinguishable items from the auction;
generating a second counter value; and
providing information to the first and second computing devices, the information comprising:
the remaining quantity, and
the second counter value.

16. The method of claim 15, wherein:
the first and second counter values are generated by a computing device of an auction service in communication with the first and second computing devices via the network, and
the second counter value is less than the first counter value.

17. The method of claim 15, wherein the first and second computing devices are in communication via a network, and one or more peer-to-peer applications operating on the first and second computing devices:
generates the first and second counter values,
determines the remaining quantity,
causes display of a first transaction history on the first computing device, the first transaction history including a first identifier uniquely identifying the first bidder, and
causes display of a second transaction history on the second computing device, the second transaction history including a second identifier different from the first identifier, the second identifier indicating the first quantity and the first counter value.

18. The method of claim 15, further comprising:
generating encrypted information by encrypting information received from at least one of the first and second computing devices; and
storing the encrypted information within computer-readable media of an auction service computing device, wherein the auction service computing device is in communication with the first and second computing devices via a network.

19. The method of claim 15, wherein the bid comprises a first bid, the method further comprising receiving a second bid for a second quantity of the substantially indistinguishable items from the second computing device, wherein:
the first bidder is participating in the auction when the second bid is received,
the first bid is received when the first counter value is active, and
the second bid is received when the second counter value is active.

20. The method of claim 15, wherein the information provided to the first computing device is different from the information provided to the second computing device.
